(19) United States
(12) Patent Application Publication
(10) Pub. No.: US 2019/0004178 A1
(43) Pub. Date: Jan. 3, 2019

(54) SIGNAL PROCESSING APPARATUS AND SIGNAL PROCESSING METHOD

(71) Applicant: SONY CORPORATION, Tokyo (JP)

(72) Inventors: Takuto MOTOYAMA, Kanagawa (JP); Yasuhiro SUTOU, Kanagawa (JP)

(73) Assignee: SONY CORPORATION, Tokyo (JP)

(21) Appl. No.: 16/069,980

(22) PCT Filed: Mar. 2, 2017
(86) PCT No.: PCT/JP2017/008288

§ 371 Date: Jul. 13, 2018

(30) Foreign Application Priority Data
Mar. 16, 2016 (JP) 2016-052668

(51) Int. Cl. G01S 17/87; G01C 3/08; H04N 13/239

(52) U.S. Cl. CPC G01S 17/87; G01S 17/936; H04N 13/239; G01C 3/085

(57) ABSTRACT

This technology relates to a signal processing apparatus and a signal processing method for obtaining the relative positional relations between sensors with higher accuracy. A positional relation estimating part of the signal processing apparatus estimates positional relations between a first coordinate system and a second coordinate system, on the basis of corresponding relations between multiple planes in the first coordinate system obtained by a first sensor on the one hand and multiple planes in the second coordinate system obtained by a second sensor on the other hand. This technology may be applied, for example, to the signal processing apparatus that estimates the positional relations between the first and the second sensors having significantly different levels of spatial resolution.

### TECHNICAL FIELD

The present technology relates to a signal processing apparatus and a signal processing method. More particularly, the technology relates to a signal processing apparatus and a signal processing method for obtaining the relative positional relations between sensors with higher accuracy.

### BACKGROUND ART

Recent years have seen the introduction of collision avoidance systems mounted on vehicles such as cars to detect vehicles and pedestrians ahead for collision avoidance.

Objects such as cars and pedestrians ahead are detected through recognition of images captured by a stereo camera or through the use of radar information from millimeter-wave radar or laser radar. Also under development are object detection systems that use both the stereo camera and laser radar in a scheme called sensor fusion.

The sensor fusion involves matching objects detected by the stereo camera against objects detected by laser radar. This requires calibrating the coordinate system of the stereo camera and that of the laser radar. For example, Patent Literature 1 discloses the method in which a dedicated calibration board with pieces of laser-absorbing and laser-reflecting materials alternated thereon in a grid-like pattern is used to detect the corner positions of each grid on the board with two sensors. The corresponding relations between the corner point coordinates are then used to estimate the translation vector and the rotation matrix between the two sensors.

### CITATION LIST

### Patent Literature

### [PTL 1]

Japanese Patent Laid-open No. 2007-218738

### SUMMARY

### Technical Problem

However, estimating the information regarding calibration between the sensors by use of point-to-point correspondence relations detected thereby can result in low levels of estimation accuracy in the case where these sensors have significantly different levels of spatial resolution.

The present technology has been devised in view of the above circumstances and is designed to obtain the relative positional relations between sensors with higher accuracy.

### Solution to Problem

According to one aspect of the present technology, there is provided a signal processing apparatus including a positional relation estimating part configured to estimate positional relations between a first coordinate system and a second coordinate system, on the basis of corresponding relations between multiple planes in the first coordinate system obtained by a first sensor on the one hand and multiple planes in the second coordinate system obtained by a second sensor on the other hand.

According to another aspect of the present technology, there is provided a signal processing method including the step of causing a signal processing apparatus to estimate positional relations between a first coordinate system and a second coordinate system, on the basis of corresponding relations between multiple planes in the first coordinate system obtained by a first sensor on the one hand and multiple planes in the second coordinate system obtained by a second sensor on the other hand.

Thus according to some aspects of the present technology, positional relations are estimated between the first coordinate system and the second coordinate system on the basis of the corresponding relations between multiple planes in the first coordinate system obtained by the first sensor on the one hand and multiple planes in the second coordinate system obtained by the second sensor on the other hand.

The signal processing apparatus may be an independent apparatus, or an internal block constituting part of a single apparatus.

Also, the signal processing apparatus may be implemented by causing a computer to execute programs. The programs for enabling the computer to function as the signal processing apparatus may be transmitted via transmission media or recorded on storage media when provided to the computer.

### Advantageous Effect of Invention

Thus according to one aspect of the present technology, it is possible to obtain the relative positional relations between sensors with higher accuracy.

It is to be noted that the advantageous effects outlined above are not limitative of the present disclosure. Further advantages of the disclosure will become apparent from the ensuing description.

### BRIEF DESCRIPTION OF DRAWINGS

FIG. 1 is an explanatory diagram explaining parameters to be obtained by a calibration process.

FIG. 2 is an explanatory diagram explaining a calibration method that uses the corresponding relations between points.

FIG. 3 is another explanatory diagram explaining the calibration method that uses the corresponding relations between points.

FIG. 4 is a block diagram depicting a typical configuration of a first embodiment of a signal processing system to which the present technology is applied.

FIG. 5 is an explanatory diagram explaining objects to be measured by a stereo camera and laser radar.

FIG. 6 is an explanatory diagram explaining a plane detecting process performed by a plane detecting part.

FIG. 7 is a conceptual diagram of a corresponding plane detecting process performed by a plane correspondence detecting part.

FIG. 8 is an explanatory diagram explaining a second calculation method for obtaining a translation vector T.

FIG. 9 is a flowchart explaining a calibration process performed by the first embodiment.

FIG. 10 is a block diagram depicting a typical configuration of a second embodiment of the signal processing system to which the present technology is applied.

FIG. 11 is an explanatory diagram explaining peak normal vectors.

FIG. 12 is an explanatory diagram explaining processing performed by a peak correspondence detecting part.

FIG. 13 is a flowchart explaining a calibration process performed by the second embodiment.

FIG. 14 is another flowchart explaining the calibration process performed by the second embodiment.

FIG. 15 is an explanatory diagram explaining a method for detecting multiple planes.

FIG. 16 is an explanatory diagram explaining a calibration process performed in the case where the signal processing system is mounted on a vehicle.

FIG. 17 is a flowchart explaining a running calibration process.

FIG. 18 is an explanatory diagram explaining the effects of the calibration processing according to the present technology.

FIG. 19 is another explanatory diagram explaining the effects of the calibration processing according to the present technology.

FIG. 20 is a block diagram depicting a typical configuration of a computer to which the present technology is applied.

FIG. 21 is a block diagram depicting a typical overall configuration of a vehicle control system.

FIG. 22 is an explanatory diagram depicting typical positions to which vehicle exterior information detecting parts and imaging parts are attached.

### DESCRIPTION OF EMBODIMENTS

The preferred modes for implementing the present technology (referred to as the embodiments) are described below. The description is given under the following headings:

1. Process overview
2. First embodiment of the signal processing system
3. Second embodiment of the signal processing system
4. Multiple planes targeted for detection
5. Vehicle mount examples
6. Typical computer configuration
7. Typical configuration of the vehicle control system

### 1. Process Overview

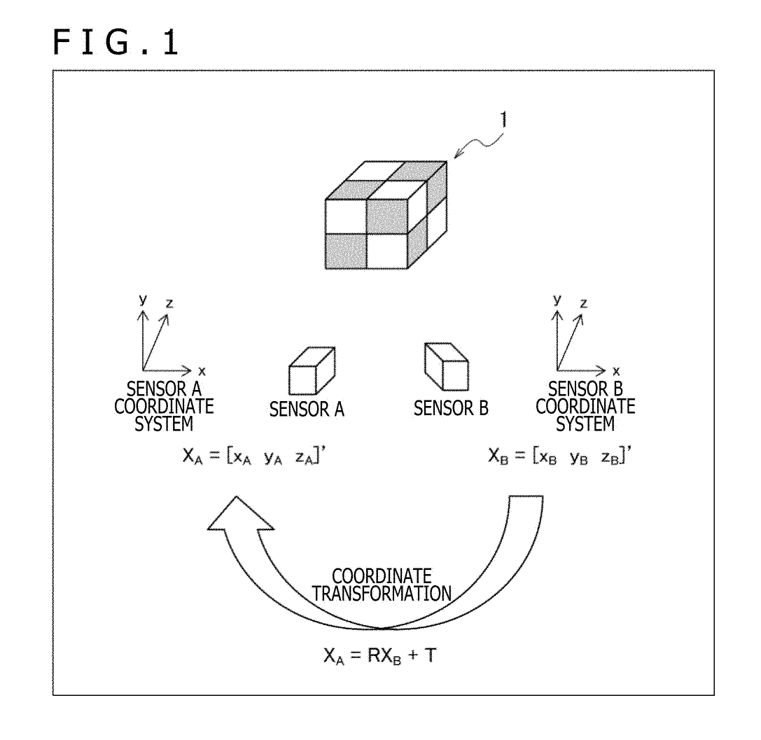

Explained first with reference to FIG. 1 are the parameters to be obtained in a calibration process performed by a signal processing apparatus, to be discussed later.

For example, a sensor A acting as a first sensor and a sensor B as a second sensor detect the same object 1 in a detection target space.

The sensor A detects a position X_{A}=[x_{A} y_{A} z_{A}]′ of the object 1 on the basis of a three-dimensional coordinate system of the sensor A (sensor A coordinate system).

The sensor B detects a position X_{B}=[x_{B} y_{B} z_{B}]′ of the object 1 on the basis of a three-dimensional coordinate system of the sensor B (sensor B coordinate system).

Here, the sensor A and the sensor B coordinate systems are each a coordinate system of which the X axis is in the horizontal direction (crosswise direction), the Y axis in the vertical direction (up-down direction), and the Z axis in the depth direction (front-back direction). “′” of the positions X_{A}=[x_{A} y_{A} z_{A}]′ and X_{B}=[x_{B} y_{B} z_{R}]′ of the object 1 represents the transposition of a matrix.

Since the sensors A and the B detect the same object 1, there exist a rotation matrix R and a translation vector T for converting, for example, the position X_{B}=[x_{B} yₑ z_{B}]′ of the object 1 in the sensor B coordinate system into the position X_{A}=[x_{A} y_{A} z_{A}]′ of the object 1 in the sensor A coordinate system.

In other words, using the rotation matrix R and translation vector T, there holds the following relational expression (1) indicative of the corresponding relations between the sensor A coordinate system and the sensor B coordinate system:

X_{A}=RX_{B}+T (1)

The rotation matrix R is represented by a three-row, three-column (3×3) matrix and the translation vector T by a three-row, one-column (3×1) vector.

The signal processing apparatus, to be discussed later, performs a calibration process for estimating the rotation matrix R and the translation vector T in the expression (1) representative of the relative positional relations between the coordinate systems possessed individually by the sensors A and B.

One calibration method for estimating the relative positional relations between the coordinate systems possessed individually by the sensors A and B is, for example, a method that uses the corresponding relations between points detected by the sensors A and B.

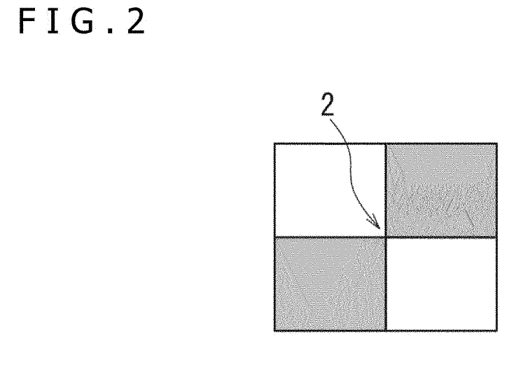

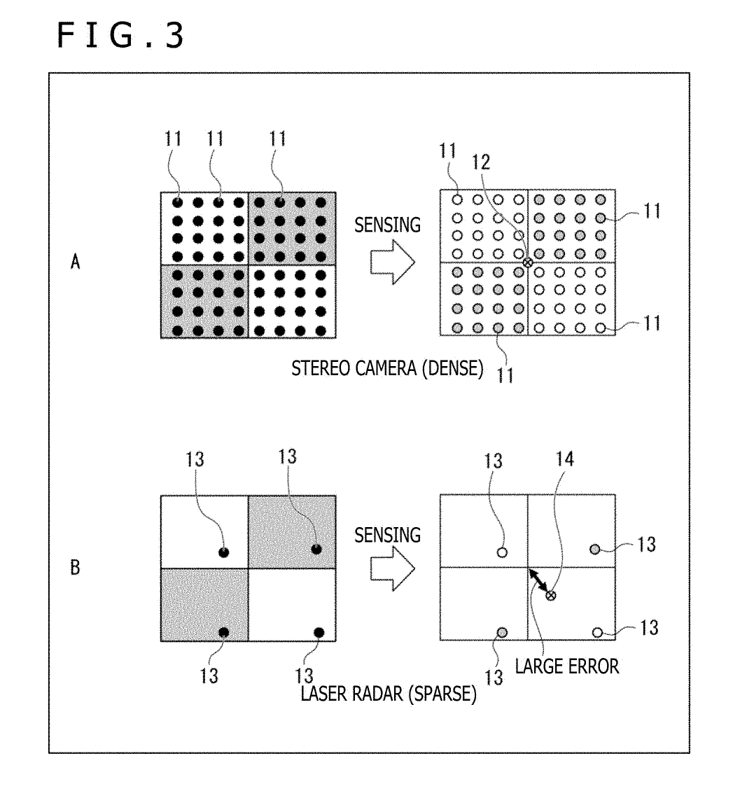

The calibration method using the corresponding relations between points detected the sensors is explained below with reference to FIGS. 2 and 3.

Suppose that the sensor A is a stereo camera and the sensor B is laser radar. Suppose also the case in which, as depicted in FIG. 2, the stereo camera and laser radar detect the coordinates of an intersection point 2 in the grid-like pattern of a given plane of the object 1 illustrated in FIG. 1.

With regard to the resolution (spatial resolution) of the three-dimensional position coordinates to be detected, it is generally said that the spatial resolution of the stereo camera is high and that of the laser radar is low.

The stereo camera with its high spatial resolution is capable of densely setting up sampling points 11 as illustrated in Subfigure A in FIG. 3. Thus the estimated position coordinates 12 of the intersection point 2, estimated from the dense sampling points 11, approximately match the position of the correct intersection point 2.

The laser radar with its low spatial resolution, on the other hand, sets sampling points 13 sparsely as depicted in Subfigure B in FIG. 3. Thus the estimated position coordinates 14 of the intersection point 2, estimated from the sparse sampling points 13, have a large error relative to the position of the correct intersection point 2.

It follows that where there is a significant difference in spatial resolution between sensors, the calibration method using the corresponding relations between points detected by these sensors may result in low levels of estimation accuracy.

Given the above circumstances, the signal processing apparatus to be discussed below uses not the corresponding relations between points detected by sensors but the corresponding relations between planes detected by sensors, with a view to achieving higher levels of calibration between different types of sensors.

### 2. First Embodiment of the Signal Processing System

### <Block Diagram>

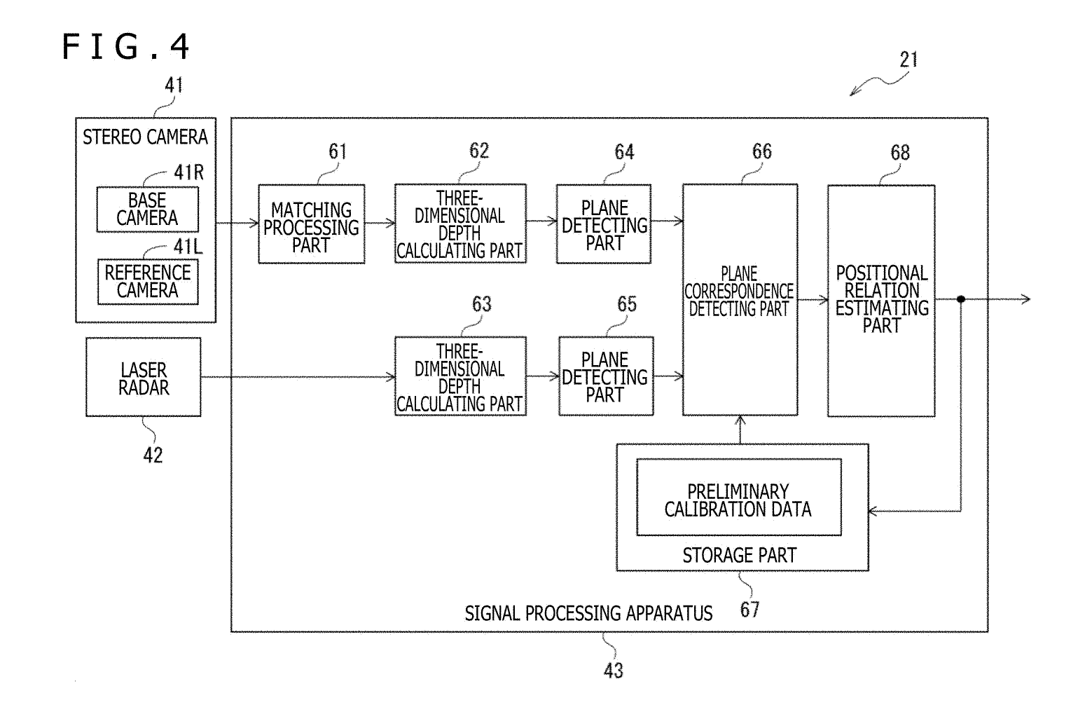

FIG. 4 is a block diagram depicting a typical configuration of a first embodiment of the signal processing system to which the present technology is applied.

The signal processing system 21 in FIG. 4 includes a stereo camera 41, laser radar 42, and a signal processing apparatus 43.

The signal processing system 21 performs a calibration process for estimating the rotation matrix R and translation vector T of the expression (1) representative of the relative positional relations between the coordinate systems possessed by the stereo camera 41 and laser radar 42. In the signal processing system 21, the stereo camera 41 corresponds to the sensor A in FIG. 1 and the laser radar 42 to the sensor B in FIG. 1, for example.

For the purpose of simplified explanation, it is assumed that the stereo camera 41 and laser radar 42 are set up in such a manner that an imaging range of the stereo camera 41 and a laser light emission range of the laser radar 42 coincide with each other. In the ensuing description, the imaging range of the stereo camera 41 and the laser light emission range of the laser radar 42 may be referred to as the visual field range where appropriate.

The stereo camera 41 includes a base camera 41R and a reference camera 41L. The base camera 41R and the reference camera 41L are arranged a predetermined distance apart horizontally at the same height, and capture images of a predetermined range (visual field range) in the direction of object detection. The image captured by the base camera 41R (called the base camera image hereunder) and the image captured by the reference camera 41L (called the reference camera image hereunder) have a parallax therebetween (discrepancy in the crosswise direction) due to the difference between the positions at which the cameras are arranged.

The stereo camera 41 outputs the base camera image and the reference camera image as sensor signals to a matching processing part 61 of the signal processing apparatus 43.

The laser radar 42 emits laser light (infrared rays) to a predetermined range in the direction of object detection (visual field range), receives light reflected from an object, and measures the ToF time (ToF: Time of Flight) from the time of laser light emission until receipt of the reflected light. The laser radar 42 outputs to a three-dimensional depth calculating part 63 a rotation angle θ around the Y axis of the emitted laser light and a rotation angle t around its X axis as sensor signals. In this embodiment, one frame (1 slice) of the images output by the base camera 41R and reference camera 41L corresponds to one unit, called a frame, of the sensor signal obtained by the laser radar 42 scanning the visual field range once. Also, the rotation angle θ around the Y axis of the emitted laser light and the rotation angle φ around its X axis are referred to as the rotation angle (θ, φ) of the emitted laser light hereunder.

The stereo camera 41 and the laser radar 42 are already calibrated individually as sensors using existing techniques. Following the calibration, the base camera image and the reference camera image output from the stereo camera 41 to the matching processing part 61 have already undergone lens distortion correction and parallelization correction of epipolar lines between the stereo camera units. Also, the scaling of the stereo camera 41 and that of the laser radar 42 are corrected to match the scaling of the real world through calibration.

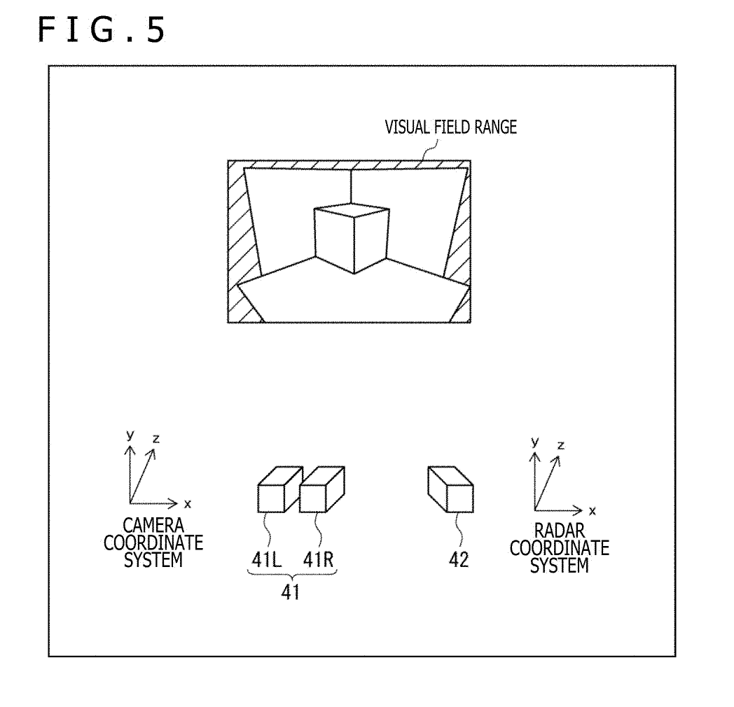

With this embodiment, there is a case where the visual field ranges of both the stereo camera 41 and the laser radar 42 include a known structure having at least three planes, as depicted in FIG. 5 for example. This case is explained below.

Returning to FIG. 4, the signal processing apparatus 43 includes the matching processing part 61, a three-dimensional depth calculating part 62, another three-dimensional depth calculating part 63, a plane detecting part 64, another plane detecting part 65, a plane correspondence detecting part 66, a storage part 67, and a positional relation estimating part 68.

The matching processing part 61 performs the process of matching the pixels of the base camera image against those of the reference camera image on the basis of the two images supplied from the stereo camera 41. Specifically, the matching processing part 61 searches the reference camera image for the pixels corresponding to those of the base camera image.

Incidentally, the matching process for detecting the corresponding pixels between the base camera image and the reference camera image may be performed using known techniques such as the gradient method and block matching.

Then the matching processing part 61 calculates amounts of parallax representative of the amounts of divergence between the positions of the corresponding pixels in the base camera image and reference camera image. The matching processing part 61 further generates a parallax map by calculating the amount of parallax for each of the pixels of the base camera image, and outputs the generated parallax map to the three-dimensional depth calculating part 62. Alternatively, since the positional relations between the base camera 41R and the reference camera 41L are precisely calibrated, the parallax map may also be generated by searching the base camera image for the pixels corresponding to those of the reference camera image.

On the basis of the parallax map supplied from the matching processing part 61, the three-dimensional depth calculating part 62 calculates the three-dimensional coordinate values (x_{A}, y_{A}, z_{A}) of each point in the visual field range of the stereo camera 41. Here, the three-dimensional coordinate values (x_{A}, y_{A}, z_{A}) of each point targeted for calculation are computed using the following expressions (2) to (4):

x_{A}=(uᵢ−u₀)*z_{A}/f (2)

y_{A}=(vᵢ−v₀)*z_{A}/f (3)

z_{A}=bf/d (4)

In the above expressions, “d” stands for the amount of parallax of a given pixel in the base camera image, “b” for the distance between the base camera 41R and the reference camera 41L, “f” for the focal point distance of the base camera 41R, (uᵢ, vᵢ) for the pixel position in the base camera image, and (u₀, v₀) for the pixel position of the optical center in the base camera image. Thus the three-dimensional coordinate values (x_{A}, y_{A}, z_{A}) of each point constitute three-dimensional coordinate values in the camera coordinate system of the base camera.

The other three-dimensional depth calculating part 63 calculates the three-dimensional coordinate values (x_{B}, y_{B}, z_{B}) of each point in the visual field range of the laser radar 42 on the basis of the rotation angle (θ, φ) and the ToF of emitted laser light supplied from the laser radar 42. Here, the three-dimensional coordinate values (x_{B}, y_{B}, z_{B}) of each point in the visual field range targeted for calculation correspond to the sampling point regarding which the rotation angle (θ, φ) and the ToF of emitted laser light have been supplied. The three-dimensional coordinate values (x_{B}, y_{B}, z_{B}) of each point thus constitute three-dimensional coordinate values in the laser coordinate system.

The plane detecting part 64 detects multiple planes in the camera coordinate system using the three-dimensional coordinate values (x_{A}, y_{A}, z_{A}) of each point in the visual field range supplied from the three-dimensional depth calculating part 62.

Likewise, the plane detecting part 65 detects multiple planes in the radar coordinate system using the three-dimensional coordinate values (x_{B}, y_{B}, z_{B}) of each point in the visual field range supplied from the three-dimensional depth calculating part 63.

The plane detecting part 64 and the plane detecting part 65 differ from each other only in that one detects planes in the camera coordinate system and the other detects planes in the radar coordinate system. These two parts perform the same plane detecting process.

### <Plane Detecting Process>

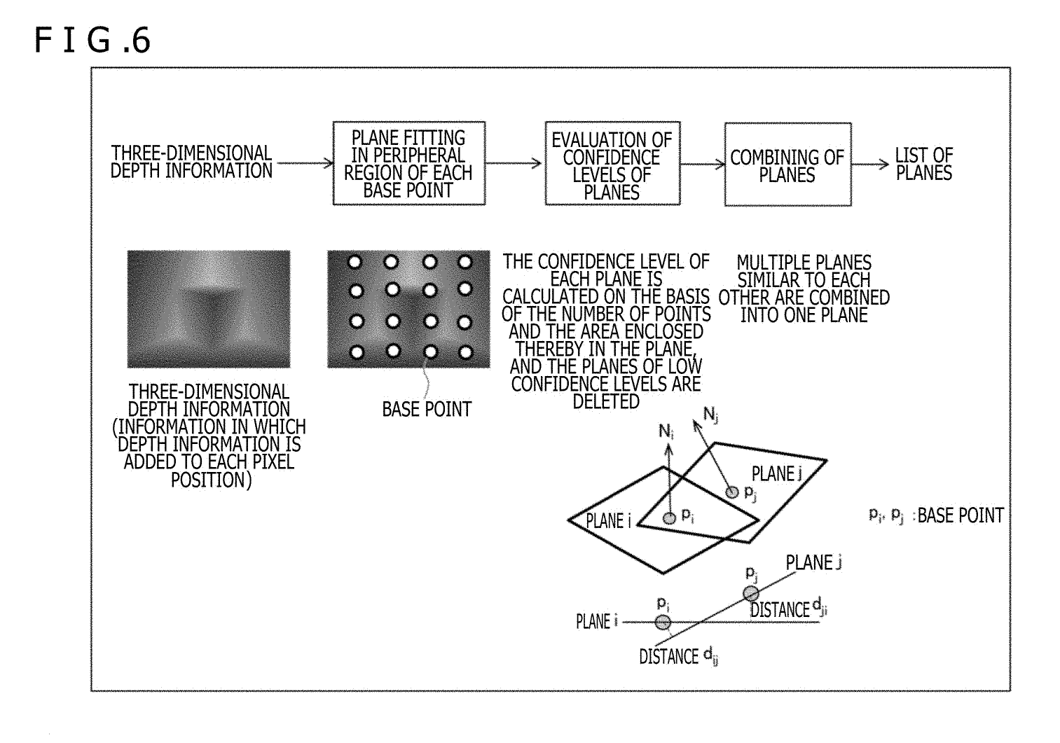

The plane detecting process performed by the plane detecting part 64 is explained below with reference to FIG. 6.

The three-dimensional depth calculating part 62 supplies the plane detecting part 64 with three-dimensional depth information in which the coordinate value z_{A} of the depth direction is added to the position (x_{A}, y_{A}) of each pixel in the base camera image to constitute the three-dimensional coordinate values (x_{A}, y_{A}, z_{A}) of each point in the visual field range of the stereo camera 41.

The plane detecting part 64 sets multiple base points beforehand in the visual field range of the stereo camera 41. Using the three-dimensional coordinate values (x_{A}, y_{A}, z_{A}) of a peripheral region of each base point that has been set, the plane detecting part 64 performs a plane fitting process of calculating planes fit for a group of points around the base point. The plane fitting method may be the least-square method or random sampling consensus (RANSAC), for example.

In the example FIG. 6, four base points by four base points are set in the visual field range of the stereo camera 41 so that 16 planes are calculated therefrom, i.e., 4×4=16. The plane detecting part 64 stores the calculated 16 planes as a list of planes.

Alternatively, the plane detecting part 64 may calculate multiple planes from the three-dimensional coordinate values (x_{A}, y_{A}, z_{A}) of each point in the visual field range using Hough transform, for example. Thus the method of detecting at least one plane from the three-dimensional coordinate values (x_{A}, y_{A}, z_{A}) of each point in the visual field range supplied from the three-dimensional depth calculating part 62 is not limited to any one method.

The plane detecting part 64 then calculates the confidence level of each plane calculated with regard to each base point, and deletes planes of low confidence levels from the list of planes. The confidence level representing the likelihood of a plane being formed may be calculated on the basis of the number of points and the area enclosed thereby in the calculated plane. Specifically, in the case where the number of points in a given plane is smaller than a predetermined threshold value (first threshold value) and where the area of a maximum region enclosed by the points in the plane is smaller than a predetermined threshold value (second threshold value), the plane detecting part 64 determines that the confidence level of the plane is low, and deletes that plane accordingly from the list of planes. Alternatively, the confidence level of a given plane may be determined using only the number of points or the area enclosed thereby in that plane.

The plane detecting part 64 then calculates the degree of similarity between multiple planes after deleting the planes of low confidence levels. The plane detecting part 64 deletes one of two planes determined to be similar to each other from the list of planes, thereby unifying multiple similar planes into one plane.

The degree of similarity may be calculated using the absolute value of the inner product between normal lines to two planes or an average value of distances (average distance) from the base points in one plane to another plane, for example.

FIG. 6 is a conceptual diagram depicting normal lines to two planes and distances from base points in one plane to another plane, the normal lines and the distances being used in calculating the degree of similarity between the planes.

Specifically, FIG. 6 illustrates a normal vector Nᵢ of a base point pᵢ in a plane i and a normal vector Nⱼ of a base point p, in a plane j. In the case where the absolute value of the inner product between the normal vectors Nᵢ and Nⱼ is at least a predetermined threshold value (third threshold value), it is determined that the planes i and j are similar to each other (the same plane)

Also, in the case where a distance dᵢⱼ from the base point pᵢ in the plane i to the plane j and a distance dⱼᵢ from the base point pⱼ in the plane j to the plane i are indicated and where the average value of the distances dᵢⱼ and dⱼᵢ is at most a predetermined threshold value (fourth threshold value), it is determined that the plane i and the plane j are similar to each other (the same plane).

After one of every two planes determined to be similar to each other is deleted from the list of planes, there ultimately remain multiple planes in the list of planes. The remaining planes are output from the plane detecting part 64 to the plane correspondence detecting part 66 as the result of the plane detecting process.

As described above, the plane detecting part 64 calculates multiple plane candidates by performing plane fitting on multiple base points, extracts some of the calculated multiple plane candidates on the basis of their confidence levels, and calculates degrees of similarity between the extracted plane candidates. In so doing, the plane detecting part 64 detects those multiple planes in the camera coordinate system that exist in the visual field range of the stereo camera 41. The plane detecting part 64 outputs a list of the detected multiple planes to the plane correspondence detecting part 66.

Each of the planes in the camera coordinate system output to the plane correspondence detecting part 66 is defined by the following expression (5):

N_{Ai}′X_{A}+d_{Ai}=0 i=1,2,3,4 (5)

In the expression (5) above, “i” stands for a variable identifying each plane in the camera coordinate system output to the plane correspondence detecting part 66; N_{A1} denotes a normal vector of the plane i defined as N_{Ai}=[nx_{Ai} ny_{Ai} nz_{Ai}]′; d_{Ai} represents a coefficient part of the plane i; and X_{A} stands for a vector representative of xyz coordinates in the camera coordinate system defined as X_{A}=[x_{A} y_{A} z_{A}]′.

Thus each plane in the camera coordinate system is defined by an equation (plane equation) that has the normal vector N_{Ai} and coefficient part d_{Ai} as its members.

The plane detecting part 65 also performs the above-described plane detecting process in like manner, using the three-dimensional coordinate values (x_{B}, y_{B}, z_{B}) of each point in the radar coordinate system supplied from the three-dimensional depth calculating part 63.

Each of the planes in the radar coordinate system output to the plane correspondence detecting part 66 is defined by the following plane equation (6) having the normal vector N_{Bi} and coefficient part d_{Bi} as its members:

N_{Bi}′X_{B}+d_{Bi}=0 i=1,2,3,4 (6)

In the equation (6) above, “i” stands for a variable identifying each plane in the radar coordinate system output to the plane correspondence detecting part 66; N_{Bi} denotes a normal vector of the plane i defined as N_{Bi}=[nx_{Bi} ny_{Bi} nz_{Bi}]′; d_{Bi} represents a coefficient part of the plane i; and X_{B} stands for a vector representative of the xyz coordinates in the radar coordinate system defined as X_{B}=[x_{B} y_{B} z_{B}]′.

Returning to FIG. 4, the plane correspondence detecting part 66 matches the list of multiple planes in the camera coordinate system supplied from the plane detecting part 64 against the list of multiple planes in the radar coordinate system supplied from the plane detecting part 65 in order to detect corresponding planes.

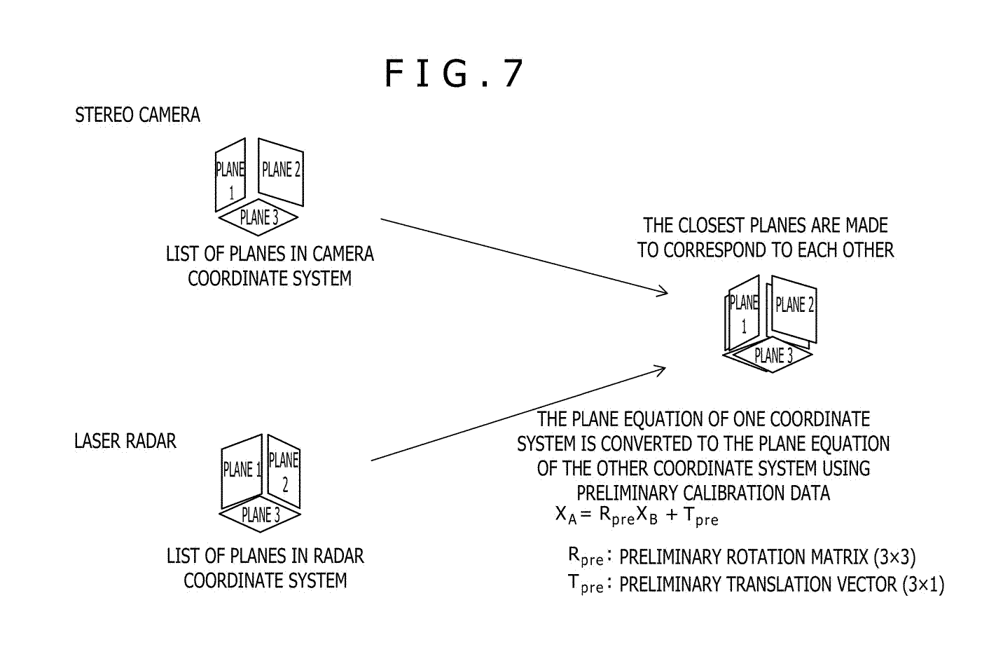

FIG. 7 is a conceptual diagram of the corresponding plane detecting process performed by the plane correspondence detecting part 66.

First, the plane correspondence detecting part 66 converts the plane equation of one coordinate system to the plane equation of the other coordinate system, using preliminary calibration data stored in the storage part 67 and the relational expression (1) above indicative of the corresponding relations between the two different coordinate systems. With this embodiment, it is assumed that the plane equations of the multiple planes in the radar coordinate system are converted to those of the multiple planes in the camera coordinate systems, for example.

The preliminary calibration data constitutes preliminary arrangement information indicative of preliminary relative positional relations between the camera coordinate system and the radar coordinate system. The information includes a preliminary rotation matrix Rpre and a preliminary translation vector Tpre, both eigenvalues corresponding to the rotation matrix R and translation vector T in the expression (1) above, respectively. Adopted as the preliminary rotation matrix Rpre and preliminary translation vector Tpre are the design data indicative of the relative positional relations between the stereo camera 41 and the laser radar 42 at design time, or the results of the calibration process carried out in the past, for example. Although the preliminary calibration data may not be accurate due to variations stemming from different production times and aging, these inaccuracies are not problematic as long as approximate position adjustment is available here.

The plane correspondence detecting part 66 then performs the process of matching the closest planes between the multiple planes detected by the stereo camera 41 on the one hand and the multiple planes detected by the laser radar 42 and converted to those in the camera coordinate system (called multiple converted planes hereunder) on the other hand.

Specifically, the plane correspondence detecting part 66 calculates two kinds of values: the absolute value Iₖₕ of the inner product between normal lines to two planes (called the normal line inner product absolute value Iₖₕ hereunder), i.e., between a plane k detected by the stereo camera 41 (k=1, 2, 3, . . . , K, where K is the total number of planes supplied from the plane detecting part 64), and a converted plane h detected by the laser radar 42 (h=1, 2, 3, . . . , H, where H is the total number of planes supplied from the plane detecting part 65); and the absolute value Dₖₕ of the distance between the centers of gravity of point groups in the two planes (called the gravity center distance absolute value Dₖₕ hereunder)

The plane correspondence detecting part 66 then extracts the combination of planes (k, h) of which the normal line inner product absolute value Iₖₕ is larger than a predetermined threshold value (fifth threshold value) and of which the gravity center distance absolute value Dₖₕ is smaller than a predetermined threshold value (sixth threshold value).

Also, the plane correspondence detecting part 66 defines a cost function Cost (k, h) of the expression (7) below by which the combination of extracted planes (k, h) is suitably weighted. The plane correspondence detecting part 66 selects, as a pair of planes, the combination of planes (k, h) that minimizes the cost function Cost (k, h).

Cost(k,h)=wd*Dₖₕ−wn*Iₖₕ (7)

In the expression (7) above, wn denotes the weight on the normal line inner product absolute value Iₖₕ, and wd represents the weight on the gravity center distance absolute value Dₖₕ.

The plane correspondence detecting part 66 outputs a list of pairs of the closest planes to the positional relation estimating part 68 as the result of the plane correspondence detecting process. Here, the plane equations defining a pair of corresponding planes output to the positional relation estimating part 68 are given as follows:

N_{Aq}′X_{A}+d_{Aq}=0 q=1,2,3,4 (8)

N_{Aq}′X_{B}+d_{Bq}=0 q=1,2,3,4 (9)

where, “q” stands for a variable identifying each pair of corresponding planes.

Returning to FIG. 4, the positional relation estimating part 68 calculates (estimates) the rotation matrix R and translation vector T of the expression (1) above representative of the relative positional relations between the camera coordinate system and the radar coordinate system, using the plane equations for the pair of corresponding planes supplied from the plane correspondence detecting part 66.

Specifically, the positional relation estimating part 68 causes the plane equation (8) above of N_{Aq}′X_{A}+d_{Aq}=0 of the camera coordinate system to be expressed as an equation of the radar coordinate system such as the following expression (10) using the relational expression (1):

N_{Aq}′(RX_{B}+T)+d_{Aq}=0

N_{Aq}′RX_{B}+N_{Aq}′T+d_{A}q=0 (10)

Because the expression (10) for one of a pair of corresponding planes coincides with the plane equation (9) for the other corresponding plane under ideal conditions, the following expressions hold:

N_{Aq}′R=N_{Bq}′ (11)

N_{Aq}′T+d_{Aq}=d_{Bq} (12)

However, it is generally difficult to obtain ideal planes with no error. Thus the positional relation estimating part 68 estimates the rotation matrix R of the expression (1) by calculating a rotation matrix R that satisfies the following expression (13):

max Store(R)=Σ{(R′N_{Aq})·N_{Bq}} q=1,2,3,4 (13)

where, RR′=R′ and R=I, with I denoting a 3×3 identity matrix.

Given the normal vectors N_{Aq} and N_{Bq} of a pair of corresponding planes as its input, the expression (13) above constitutes an expression for calculating the rotation matrix R that maximizes the inner product between the normal vector N_{Aq} of one of the paired planes multiplied by a rotation matrix R′ on the one hand, and the normal vector N_{Bq} of the other plane on the other hand. Incidentally, the rotation matrix R may be expressed using a quaternion.

The positional relation estimating part 68 then calculates the translation vector T through the use of either a first calculation method using least square or a second calculation method using the coordinates of an intersection point between three planes.

According to the first calculation method using least square, the positional relation estimating part 68 calculates the vector T that minimizes the following cost function Cost (T) given the expression (12) above:

min Cost(T)=Σ{N_{Aq}′T+d_{Aq}−d_{Bq}}² (14)

The expression (14) above is an expression for estimating the translation vector T by solving, using the least square method, a translation vector T that minimizes the expression (12) above in which the coefficient part of the converted plane equation (1) having converted the plane equation N_{Aq}′X_{A}+d_{Aq}=0 of the camera coordinate system to the radar coordinate system is equal to the coefficient part of the plane equation (9) of the radar coordinate system.

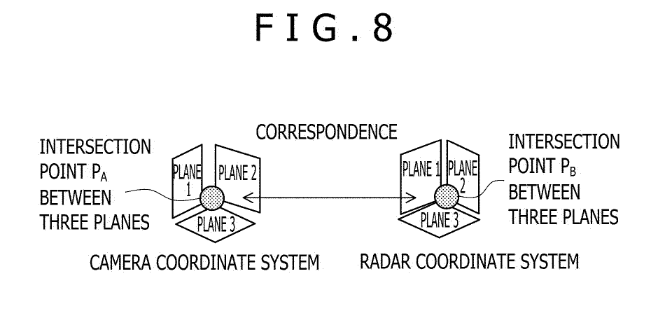

On the other hand, according to the second calculation method using the intersection coordinates of three planes, it is assumed that the intersection coordinates of three planes in the camera coordinate system are given as P_{A}=[x_{pA} y_{pA} z_{pA}]′ and that the intersection coordinates of three planes in the radar coordinate system are given as P_{B}=[x_{pB} y_{pB} z_{pB}]′, as depicted in FIG. 8, for example. These three planes are common to the two coordinate systems. In the case where the three planes intersect with one another at only one point, the coordinate systems for P_{A} and P_{B} are different but presumably designate the same point. Thus inserting the coordinate values of P_{A} and P_{B} in the equation (1) above gives the following expression (15):

P_{A}=RP_{B}+T (15)

Here, the rotation matrix R is already known, so that the positional relation estimating part 68 can obtain the translation vector T.

The positional relation estimating part 68 outputs the rotation matrix R and translation vector T calculated as described above to the outside as sensor-to-sensor calibration data, which is also stored into the storage part 67. The sensor-to-sensor calibration data supplied to the storage part 67 overwrites existing data therein and is stored as the preliminary calibration data.

### <First Calibration Process>

Explained below with reference to the flowchart of FIG. 8 is a calibration process performed by the first embodiment of the signal processing system 21 (i.e., first calibration process). This process is started, for example, when an operation part or other suitable controls, not illustrated, of the signal processing system 21 are operated to initiate the process of calibration.

First in step S1, the stereo camera 41 images a predetermined range in the direction of object detection to generate a base camera image and a reference camera image, and outputs the generated images to the matching processing part 61.

In step S2, given the base camera image and the reference camera image from the stereo camera 41, the matching processing part 61 performs the process of matching the pixels of one image against those of the other image. On the basis of the result of the matching process, the matching processing part 61 generates a parallax map in which the amounts of parallax for the pixels in the base camera image are calculated. The matching processing part 61 outputs the generated parallax map to the three-dimensional depth calculating part 62.

In step S3, on the basis of the parallax map supplied from the matching processing part 61, the three-dimensional depth calculating part 62 calculates the three-dimensional coordinate values (x_{A}, y_{A}, z_{A}) of each point in the visual field range of the stereo camera 41. The three-dimensional depth calculating part 62 then outputs the three-dimensional coordinate values (x_{A}, y_{A}, z_{A}) of each point in the visual field range to the plane detecting part 64 as three-dimensional depth information in which the coordinate value z_{A} of the depth direction is added to the position (x_{A}, y_{A}) of each pixel in the base camera image.

In step S4, the plane detecting part 64 detects multiple planes in the camera coordinate system using the three-dimensional coordinate values (x_{A}, y_{A}, z_{A}) of each point in the visual field range supplied from the three-dimensional depth calculating part 62.

In step S5, the laser radar 42 emits laser light to a predetermined range in the direction of object detection, and receives light reflected from an object to obtain the rotation angle (θ, φ) and the ToF of the emitted laser light thus received. Following receipt of the reflected light, the laser radar 42 outputs the resulting rotation angle (θ, φ) and ToF to the three-dimensional depth calculating part 63.

In step S6, on the basis of the rotation angle (θ, φ) and ToF of the emitted laser light supplied from the laser radar 42, the three-dimensional depth calculating part 63 calculates the three-dimensional coordinate values (x_{B}, y_{B}, z_{B}) of each point in the visual field range of the laser radar 42. The three-dimensional depth calculating part 63 outputs the calculated three-dimensional coordinate values (x_{B}, y_{B}, z_{B}) to the plane detecting part 65 as three-dimensional depth information.

In step S7, the plane detecting part 65 detects multiple planes in the radar coordinate system using the three-dimensional coordinate values (x_{B}, y_{B}, z_{B}) of each point in the visual field range supplied from the three-dimensional depth calculating part 63.

Incidentally, the processes of steps S1 to S4 and the processes of steps S5 to S7 may be performed in a parallel and simultaneous manner. Alternatively, the processes of steps S5 to S7 may be carried out prior to the processes of steps S1 to S4.

In step S8, the plane correspondence detecting part 66 matches the list of multiple planes supplied from the plane detecting part 64 against the list of multiple planes fed from the plane detecting part 65 so as to detect corresponding relations between the planes in the camera coordinate system and those in the radar coordinate system. Following the detection, the plane correspondence detecting part 66 outputs a list of pairs of corresponding planes to the positional relation estimating part 68.

In step S9, the positional relation estimating part 68 determines whether there exist at least three pairs of corresponding planes supplied from the plane correspondence detecting part 66. Because at least three planes are required for only one intersection point to be formed therebetween, as will be discussed later in step S11, the determination in step S9 involves ascertaining whether the number of pairs of corresponding planes at least equals a threshold value of three (seventh threshold value). It is to be noted, however, that the larger the number of pairs of corresponding planes, the higher the accuracy of calibration becomes. In view of this, the positional relation estimating part 68 may alternatively set the threshold value for the determination in step S9 to be a value larger than three.

In the case where it is determined in step S9 that the number of pairs of corresponding planes is smaller than three, the positional relation estimating part 68 determines that the calibration process has failed, and terminates the calibration process.

On the other hand, in the case where it is determined in step S9 that the number of pairs of corresponding planes is at least three, control is transferred to step S10. In step S10, the positional relation estimating part 68 selects three pairs of planes from the list of the pairs of corresponding planes.

Then in step S11, the positional relation estimating part 68, given the selected three pairs of planes, determines whether there exists only one intersection point between the three planes in the camera coordinate system as well as between the three planes in the radar coordinate system. Whether or not only one intersection point exists between the three planes may be determined by verifying whether the rank of an aggregate matrix of normal vectors of the three planes is at least three.

In the case where it is determined in step S11 that only one intersection point does not exist, control is transferred to step S12. In step S12, the positional relation estimating part 68 determines whether there exists any other combination of three pairs of planes in the list of the pairs of corresponding planes.

In the case where it is determined in step S12 that there exists no other combination of three pairs of planes, the positional relation estimating part 68 determines that the calibration process has failed, and terminates the calibration process.

On the other hand, in the case where it is determined in step S12 that there exists another combination of three pairs of planes, control is returned to step S10, and the subsequent steps are carried out. In the process of step S10 for the second time or thereafter, what is selected is a combination of three pairs of planes that is different from the other combinations of three pairs of planes selected so far.

Meanwhile, in the case where it is determined in step S11 that there exists only one intersection point, control is transferred to step S13. In step S13, the positional relation estimating part 68 calculates (estimates) the rotation matrix R and the translation vector T of the expression (1) above using the plane equations of the paired corresponding planes supplied from the plane correspondence detecting part 66.

More specifically, the positional relation estimating part 68 first estimates the rotation matrix R of the expression (1) by expressing the plane equation N_{Aq}′X_{A}+d_{Aq}=0 of the camera coordinate system in terms of the radar coordinate system so as to calculate the rotation matrix R that satisfies the expression (13) above.

The positional relation estimating part 68 then calculates the translation vector T through the use of either the first calculation method using least square or the second calculation method using the coordinates of an intersection point between three planes.

Then in step S14, the positional relation estimating part 68 determines whether the calculated rotation matrix R and translation vector T deviate significantly from the preliminary calibration data. In other words, the positional relation estimating part 68 determines whether the differences between the calculated rotation matrix R and translation vector T on the one hand and the preliminary rotation matrix Rpre and preliminary translation vector Tpre in the preliminary calibration data on the other hand fall within predetermined ranges.

In the case where it is determined in step S14 that the calculated rotation matrix R and translation vector T deviate significantly from the preliminary calibration data, the positional relation estimating part 68 determines that the calibration process has failed, and terminates the calibration process.

On the other hand, in the case where it is determined in step S14 that the calculated rotation matrix R and translation vector T do not deviate significantly from the preliminary calibration data, the positional relation estimating part 68 outputs the calculated rotation matrix R and translation vector T to the outside as sensor-to-sensor calibration data, which is also supplied to the storage part 67. The sensor-to-sensor calibration data supplied to the storage part 67 overwrites existing data therein and is stored as the preliminary calibration data.

This brings to an end the calibration process performed by the first embodiment.

### 3. Second Embodiment of the Signal Processing System

A second embodiment of the signal processing system is explained below.

### <Block Diagram>

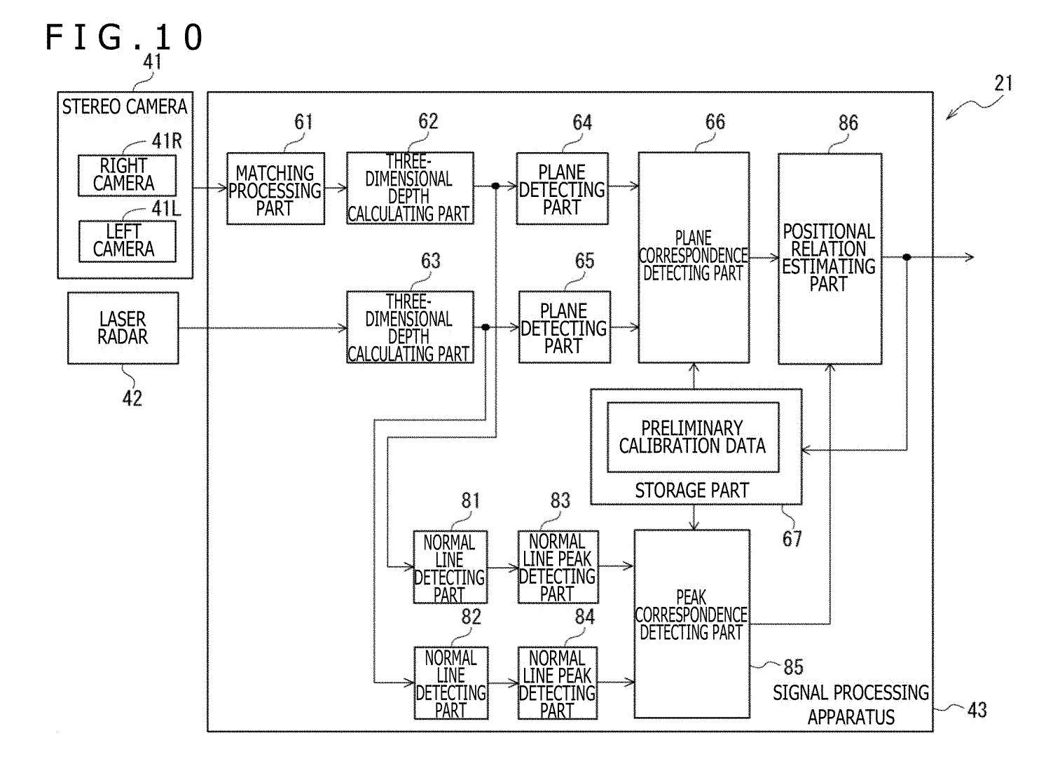

FIG. 10 is a block diagram depicting a typical configuration of the second embodiment of the signal processing system to which the present technology is applied.

In FIG. 10, the parts corresponding to those in the above-described first embodiment are designated by like reference numerals, and their explanations are omitted hereunder where appropriate.

With the above-described first embodiment, the rotation matrix R is estimated on the basis of the expression (11) above that assumes the coefficient part of the variable X_{B} is the same in the expressions (9) and (10). The second embodiment, in contrast, estimates the rotation matrix R using normal line distribution.

For that reason, the signal processing apparatus 43 of the second embodiment newly includes normal line detecting parts 81 and 82, normal line peak detecting parts 83 and 84, and a peak correspondence detecting part 85.

Further, a positional relation estimating part 86 of the second embodiment differs from the positional relation estimating part 68 of the first embodiment in that the positional relation estimating part 86 estimates the rotation matrix R not on the basis of the expression (11) but by use of information (pairs of peak normal vectors, to be discussed later) supplied from the peak correspondence detecting part 85.

The rest of the configuration of the signal processing system 21 is similar to that of the first embodiment, including the stereo camera 41 and the laser radar 42, as well as the matching processing part 61, three-dimensional depth calculating parts 62 and 63, plane detecting parts 64 and 65, plane correspondence detecting part 66, and storage part 67 of the signal processing apparatus 43.

The three-dimensional depth calculating part 62 supplies the normal line detecting part 81 with the three-dimensional coordinate values (x_{A}, y_{A}, z_{A}) of each point in the visual field range of the stereo camera 41. The normal line detecting part 81 detects a unit normal vector of each point in the visual field range of the stereo camera 41 using the three-dimensional coordinate values (x_{A}, y_{A}, z_{A}) of each point in the visual field range supplied from the three-dimensional depth calculating part 62.

The three-dimensional depth calculating part 63 supplies the normal line detecting part 82 with the three-dimensional coordinate values (x_{B}, y_{B}, z_{B}) of each point in the visual field range of the laser radar 42. The normal line detecting part 82 detects a unit normal vector of each point in the visual field range of the laser radar 42 using the three-dimensional coordinate values (x_{B}, y_{B}, z_{R}) of each point in the visual field range supplied from the three-dimensional depth calculating part 63.

The normal line detecting parts 81 and 82 are different from each other only in that one part performs the unit normal vector detecting process on each point in the camera coordinate system and the other part carries out the unit normal vector detecting process on each point in the radar coordinate system. The unit normal vector detecting process to be performed is the same with both normal line detecting parts 81 and 82.

The unit normal vector of each point in the visual field range is obtained by setting up a point group in a local region present in a sphere with a radius k centering on the three-dimensional coordinate values of the point targeted for detection and by performing principal component analysis of vectors originating from the gravity center of the point group. Alternatively, the unit normal vector of each point in the visual field range may be acquired by cross product calculation using the coordinates of points around the target point.

The normal line peak detecting part 83 generates a histogram of unit normal vectors using the unit normal vectors of each point supplied from the normal line detecting part 81. The normal line peak detecting part 83 then detects a unit normal vector of which the histogram frequency is higher than a predetermined threshold value (eighth threshold value) and which constitutes a maximum value in the distribution of the unit normal vectors.

The normal line peak detecting part 84 generates a histogram of unit normal vectors using the unit normal vectors of each point supplied from the normal line detecting part 82. The normal line peak detecting part 84 then detects a unit normal vector of which the histogram frequency is higher than a predetermined threshold value (ninth threshold value) and which constitutes a maximum value in the distribution of the unit normal vectors. The eighth threshold value and the ninth threshold value may be the same or may be different from each other.

In the ensuing description, each unit normal vector detected by the normal line peak detecting part 83 or 84 is referred to as the peak normal vector.

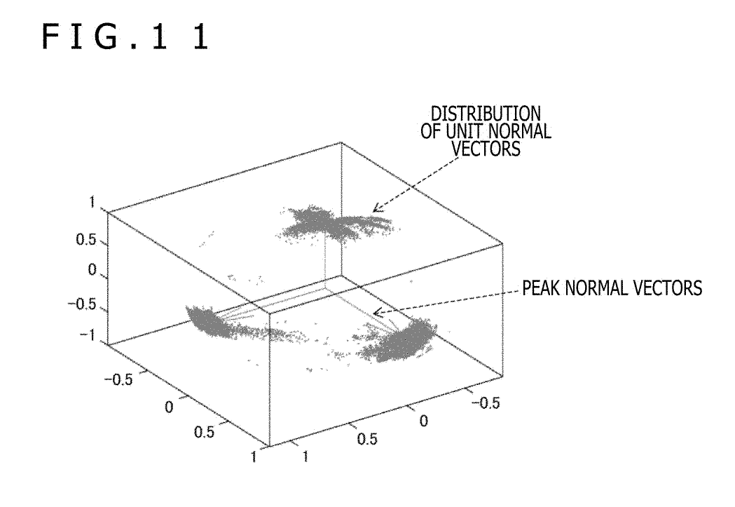

The distribution of points depicted in FIG. 11 is a distribution of the unit normal vectors detected by the normal line peak detecting part 83 or 84. Solid line arrows indicate typical peak normal vectors detected by the normal line peak detecting part 83 or 84.

The normal line peak detecting part 83 and the normal line detecting part 82 use the same method of detecting peak normal vectors. What is different is that the normal line peak detecting part 83 processes the points in the visual field range of the stereo camera 41, whereas the normal line detecting part 82 processes the points in the visual field range of the laser radar 42. The method of detecting peak normal vectors takes advantage of the fact that unit normal vectors are concentrated in the direction of a three-dimensional plane that may exist in the visual field range, with peaks appearing when a histogram is generated. Given the three-dimensional planes present in the visual fiend range, the normal line peak detecting parts 83 and 84 supply the peak correspondence detecting part 85 with at least one peak normal vector having a plane area larger (wider) than a predetermined size.

Returning to FIG. 10, the peak correspondence detecting part 85 detects a pair of corresponding peak normal vectors using at least one peak normal vector in the camera coordinate system supplied from the normal line peak detecting part 83 and at least one peak normal vector in the radar coordinate system fed from the normal line peak detecting part 84. The peak correspondence detecting part 85 outputs the detected pair of corresponding peak normal vectors to the positional relation estimating part 86.

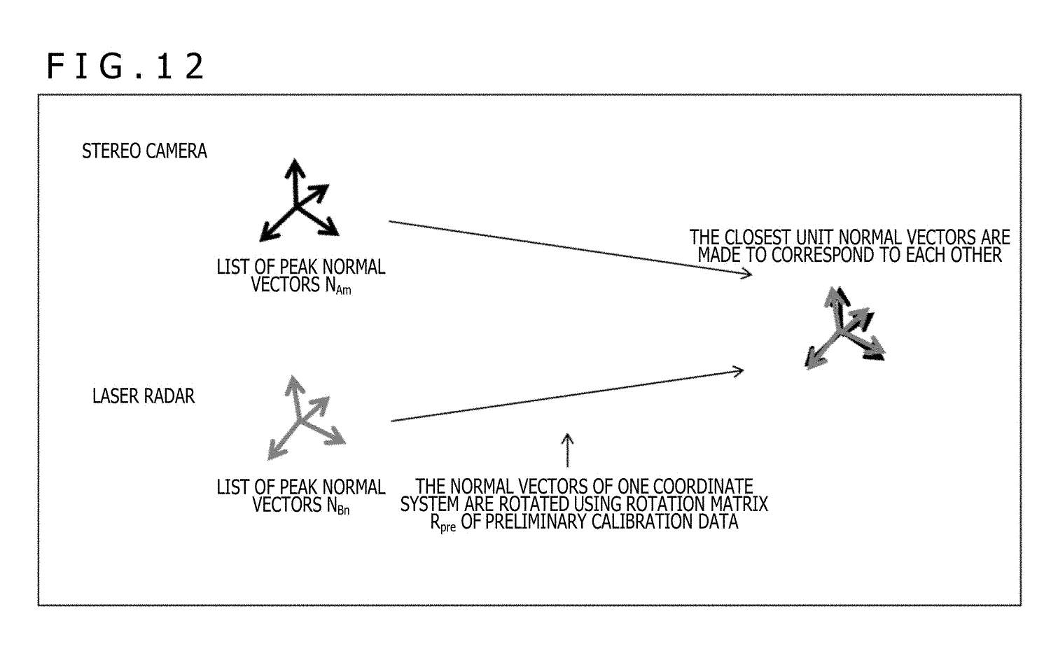

Specifically, if the peak normal vector obtained by the stereo camera 41 is defined as N_{Am} (m=1, 2, 3, . . . ) and the peak normal vector acquired by the laser radar 42 as N_{Bn} (n=1, 2, 3, . . . ), then the peak correspondence detecting part 85 makes the peak normal vectors correspond to each other in such a manner that the inner product between the peak normal vectors Rpre′N_{Am} and N_{Bn} is maximized. This process involves, as depicted in FIG. 12, rotating the peak normal vector of one side NA obtained by the stereo camera 41 and the peak normal vector of the other side (the peak normal vector N_{Bn} in FIG. 12) obtained by the laser radar 42 using the preliminary rotation matrix Rpre in such a manner that the closest unit normal vectors out of the rotated peak normal vector N_{Bn} and of the peak normal vector N_{Am} are made to correspond to each other.

It is to be noted that the peak correspondence detecting part 85 excludes any pair of corresponding peak normal vectors of which the inner product between the vectors Rpre′N_{Am} and N_{Bn} is smaller than a predetermined threshold value (tenth threshold value).

The peak correspondence detecting part 85 outputs a list of the pairs of corresponding peak normal vectors to the positional relation estimating part 86.

The positional relation estimating part 86 calculates (estimates) the rotation matrix R of the expression (1) above using the paired corresponding peak normal vectors supplied from the peak correspondence detecting part 85.

Specifically, whereas the positional relation estimating part 68 of the first embodiment inputs the normal vectors N_{Aq} and N_{Bq} of the paired corresponding planes into the expression (13) above, the positional relation estimating part 86 of the second embodiment instead inputs the normal vectors NA, and N_{Bn} as the paired corresponding peak normal vectors into the expression (13). The rotation matrix R that maximizes the inner product between the vector obtained by multiplying the peak normal vector N_{Am} of one side by the rotation matrix R′ and the peak normal vector N_{Bn} of the other side is calculated as the result of the estimation.

As with the first embodiment, the positional relation estimating part 86 calculates the translation vector T by one of two calculation methods: the first calculation method using least square, or the second calculation method using the coordinates of an intersection point between three planes.

### <Second Calibration Process>

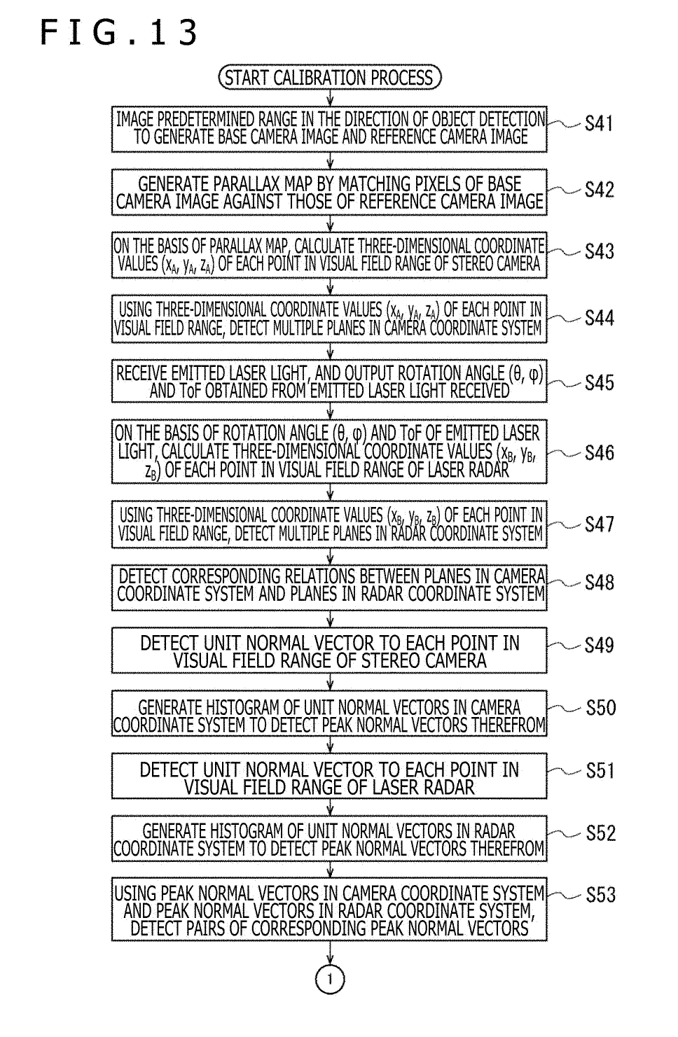

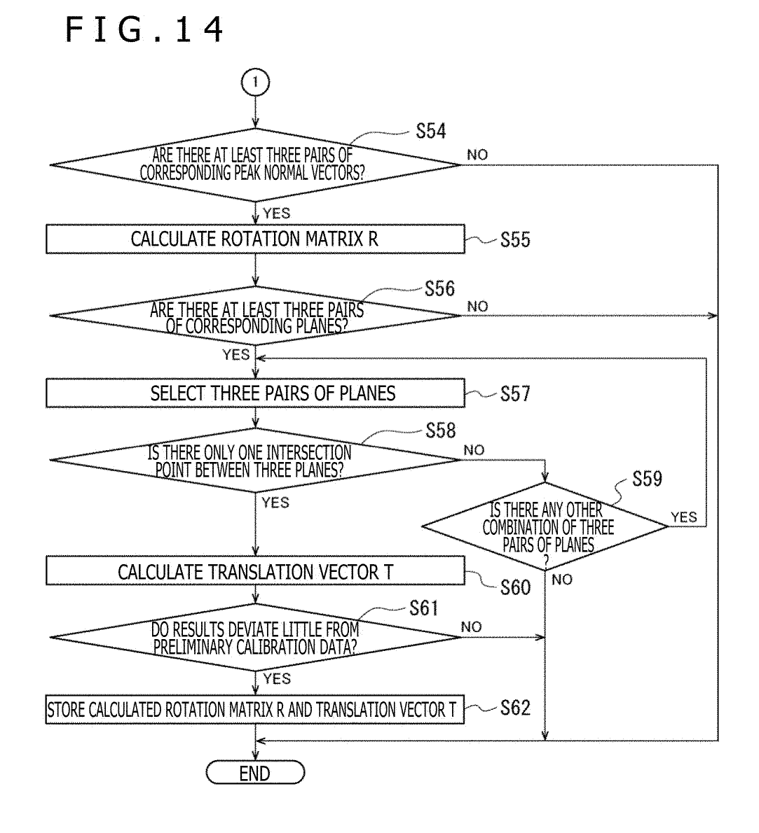

Explained next with reference to the flowcharts of FIGS. 13 and 14 is a second calibration process performed by the second embodiment of the signal processing system 21 (i.e., second calibration process). This process is started, for example, when an operation part or other suitable controls, not illustrated, of the signal processing system 21 are operated to initiate the process of calibration.

The processes of steps S41 to S48 with the second embodiment are substantially the same as those of steps S1 to S8 with the first embodiment and thus will not be discussed further. What makes the second calibration process different, however, from the first calibration process is that the three-dimensional depth information calculated by the three-dimensional depth calculating part 62 in step S43 is supplied to the normal line detecting part 81 in addition to the plane detecting part 64 and that the three-dimensional depth information calculated by the three-dimensional depth calculating part 63 in step S46 is supplied to the normal line detecting part 82 in addition to the plane detecting part 65.

In step S49 following step S48, the normal line detecting part 81 detects the unit normal vector of each point in the visual field range of the stereo camera 41 using the three-dimensional coordinate values (x_{A}, y_{A}, z_{A}) of each of these points in the visual field range of the stereo camera 41, supplied from the three-dimensional depth calculating part 62. The normal line detecting part 81 outputs the detected unit normal vectors to the normal line peak detecting part 83.

In step S50, the normal line peak detecting part 83 generates a histogram of unit normal vectors in the camera coordinate system using the unit normal vectors of the points supplied from the normal line detecting part 81, and detects peak normal vectors from the histogram. The detected peak normal vectors are supplied to the peak correspondence detecting part 85.

In step S51, the normal line detecting part 82 detects the unit normal vector of each point in the visual field range of the laser radar 42 using the three-dimensional coordinate values (x_{B}, y_{B}, z_{B}) of each of these points supplied from the three-dimensional depth calculating part 63. The normal line detecting part 82 outputs the detected unit normal vectors to the normal line peak detecting part 84.

In step S52, the normal line peak detecting part 84 generates a histogram of unit normal vectors in the radar coordinate system using the unit normal vectors of the points supplied from the normal line detecting part 82, and detects peak normal vectors from the histogram. The detected peak normal vectors are supplied to the peak correspondence detecting part 85.

In step S53, the peak correspondence detecting part 85 detects a pair of corresponding peak normal vectors using at least one peak normal vector in the camera coordinate system supplied from the normal line peak detecting part 83 and at least one peak normal vector in the radar coordinate system fed from the normal line peak detecting part 84. The peak correspondence detecting part 85 outputs the detected pair of corresponding peak normal vectors to the positional relation estimating part 86.

In step S54 of FIG. 14, the positional relation estimating part 86 determines whether the number of pairs of corresponding peak normal vectors supplied from the peak correspondence detecting part 85 is at least three. The threshold value (eleventh threshold value) for the determination in step S54 may alternatively be set to be larger than three to improve the accuracy of calibration.

In the case where it is determined in step S54 that the number of pairs of corresponding peak normal vectors is smaller than three, the positional relation estimating part 86 determines that the calibration process has failed, and terminates the calibration process.

On the other hand, in the case where it is determined in step S54 that the number of pairs of corresponding peak normal vectors is at least three, control is transferred to step S55. In step S55, the positional relation estimating part 86 calculates (estimates) the rotation matrix R of the expression (1) above using the paired corresponding peak normal vectors supplied from the peak correspondence detecting part 85.

Specifically, the positional relation estimating part 86 inputs the normal vectors N, and N_{Bn} as a pair of corresponding peak normal vectors into the expression (13) above in order to calculate the rotation matrix R that maximizes the inner product between the vector obtained by multiplying the peak normal vector NA by the rotation matrix R′ and the peak normal vector N_{Bn}.

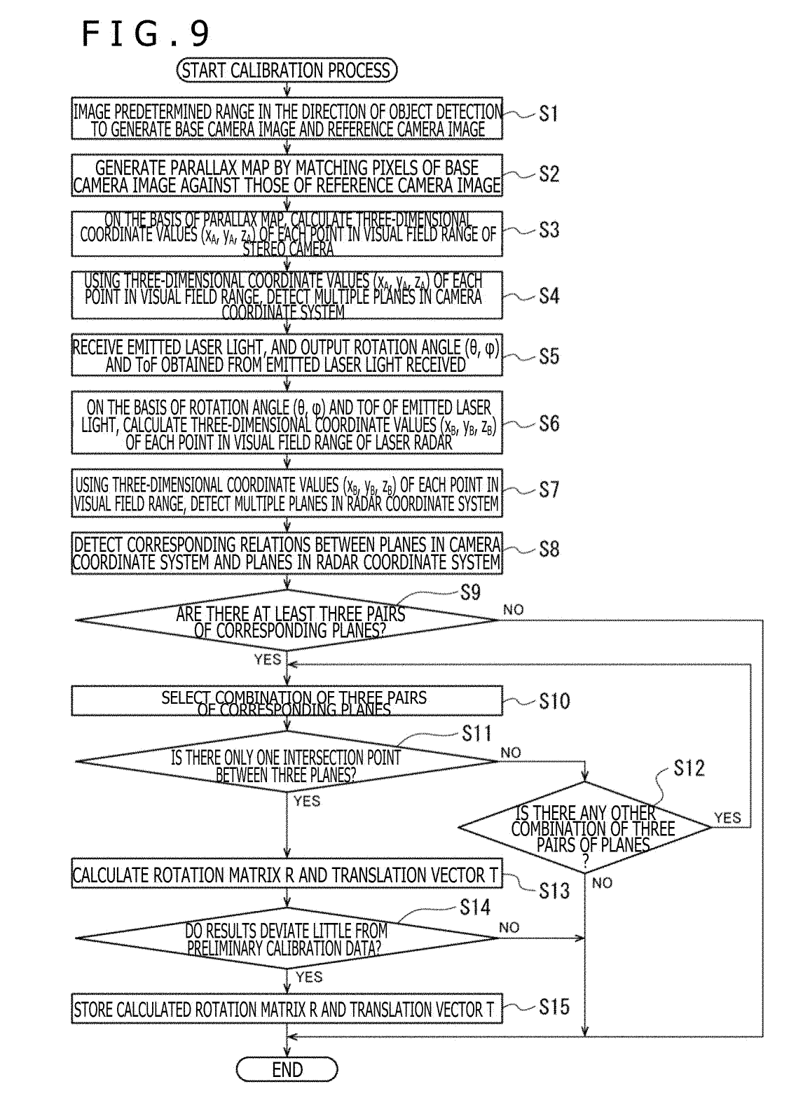

The subsequent processes of steps S56 to S62 correspond respectively to those of steps S9 to S15 with the first embodiment in FIG. 9. The processes of steps S56 to S62 are thus the same as those of steps S9 to S15, with the exception of the process of step S60 corresponding to step S13 in FIG. 9.

Specifically, in step S56, the positional relation estimating part 86 determines whether the number of pairs of corresponding planes detected in the process of step S48 is at least three. As in step S9 of the above-described first calibration process, the threshold value (twelfth threshold value) for the determination in step S56 may also be set to be larger than three.

In the case where it is determined in step S56 that the number of pairs of corresponding planes is smaller than three, the positional relation estimating part 86 determines that the calibration process has failed, and terminates the calibration process.

On the other hand, in the case where it is determined in step S56 that the number of pairs of corresponding planes is at least three, control is transferred to step S57. In step S57, the positional relation estimating part 86 selects three pairs of planes from the list of the pairs of corresponding planes.

Then in step S58, the positional relation estimating part 86, given the selected three pairs of planes, determines whether there exists only one intersection point between the three planes in the camera coordinate system as well as between the three planes in the radar coordinate system. Whether or not only one intersection point exists between the three planes may be determined by verifying whether the rank of an aggregate matrix of normal vectors of the three planes is at least three.

In the case where it is determined in step S58 that only one intersection point does not exist, control is transferred to step S59. In step S59, the positional relation estimating part 86 determines whether there exists any other combination of three pairs of planes in the list of the pairs of corresponding planes.

In the case where it is determined in step S59 that there exists no other combination of three pairs of planes, the positional relation estimating part 86 determines that the calibration process has failed, and terminates the calibration process.

On the other hand, in the case where it is determined in step S59 that there exists another combination of three pairs of planes, control is returned to step S57, and the subsequent steps are carried out. In the process of step S57 for the second time or thereafter, what is selected is a combination of three pairs of planes that is different from the other combinations of three pairs of planes selected so far.

Meanwhile, in the case where it is determined in step S58 that there exists only one intersection point, control is transferred to step S60. In step S60, the positional relation estimating part 86 calculates (estimates) the translation vector T using the plane equations of the paired corresponding planes supplied from the plane correspondence detecting part 66. More specifically, the positional relation estimating part 86 calculates the translation vector T through the use of either the first calculation method using least square or the second calculation method using the coordinates of an intersection point between three planes.

In step S61, the positional relation estimating part 86 determines whether the calculated rotation matrix R and translation vector T deviate significantly from the preliminary calibration data. In other words, the positional relation estimating part 86 determines whether the differences between the calculated rotation matrix R and translation vector T on the one hand and the preliminary rotation matrix Rpre and preliminary translation vector Tpre in the preliminary calibration data on the other hand fall within predetermined ranges.

In the case where it is determined in step S61 that the calculated rotation matrix R and translation vector T deviate significantly from the preliminary calibration data, the positional relation estimating part 86 determines that the calibration process has failed, and terminates the calibration process.

On the other hand, in the case where it is determined in step S61 that the calculated rotation matrix R and translation vector T do not deviate significantly from the preliminary calibration data, the positional relation estimating part 86 outputs the calculated rotation matrix R and translation vector T to the outside as sensor-to-sensor calibration data, which is also supplied to the storage part 67. The sensor-to-sensor calibration data supplied to the storage part 67 overwrites existing data therein and is stored as the preliminary calibration data.

This brings to an end the calibration process performed by the second embodiment.

It was explained in connection with the above examples that the processes of the steps involved are performed sequentially. Alternatively, the processes of these steps may be carried out in parallel where appropriate.

For example, the processes of steps S41 to S43 for calculating three-dimensional depth information based on the images obtained from the stereo camera 41 may be performed in parallel with the processes of steps S44 to S46 for calculating three-dimensional depth information on the basis of the radar information acquired from the laser radar 42.

Also, the processes of steps S44, S47, and S48 for detecting multiple planes in the camera coordinate system and multiple planes in the radar coordinate system to find pairs of corresponding planes may be carried out in parallel with the processes of step S49 to S55 for detecting at least one peak normal vector in the camera coordinate system and at least one peak normal vector in the radar coordinate system to find pairs of corresponding peak normal vectors.

Further, the processes of steps S49 and S50 and the processes of steps S51 and S52 may be performed in a parallel and simultaneous manner. Alternatively, the processes of steps S49 and S50 may be carried out prior to the processes of steps S51 and S52.

In each of the above-described embodiments, the plane correspondence detecting part 66 automatically (i.e., on its own initiative) detects pairs of corresponding planes using the cost function Cost (k, h) of the expression (7) above. Alternatively, the user may be prompted to manually designate pairs of corresponding planes. For example, the plane correspondence detecting part 66 may only perform coordinate transformation involving converting the plane equations of one coordinate system to those of the other coordinate system. As depicted in FIG. 7, the plane correspondence detecting part 66 may then cause the display part of the signal processing apparatus 43 or an external display apparatus to display multiple planes in one coordinate system and multiple planes in the other coordinate system. With the display thus presented, the plane correspondence detecting part 66 may prompt the user to designate pairs of corresponding planes by operation of a mouse, by touches on a screen surface, or by input of numbers, for example.

As another alternative, the plane correspondence detecting part 66 may first detect pairs of corresponding planes. Thereafter, the plane correspondence detecting part 66 may cause the display part of the signal processing apparatus 43 to display the result of the detection. In turn, the user may modify or delete the pairs of corresponding planes as needed.

### 4. Multiple Planes Targeted for Detection

In each of the above embodiments, as explained above with reference to FIG. 5, the signal processing system 21 causes the stereo camera 41 and the laser radar 42 each to detect multiple planes in an environment such that these multiple planes targeted for detection are included in single-frame sensor signals obtained by the stereo camera 41 and laser radar 42 sensing their respective visual field ranges.

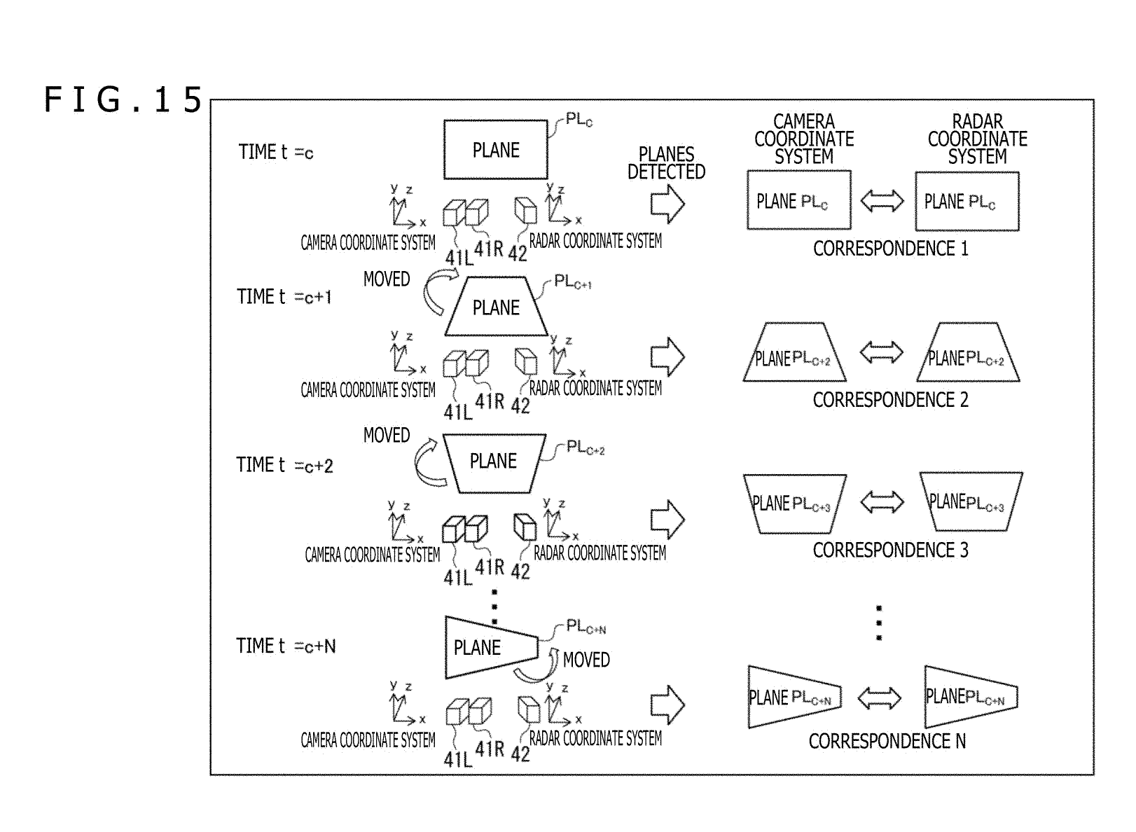

However, as depicted in FIG. 15 for example, the signal processing system 21 may detect one plane PL from a single-frame sensor signal at a given time and carry out the single-frame sensing process N times to detect multiple planes.

FIG. 15 indicates that the stereo camera 41 and the laser radar 42 each detect one plane PL_{c} at time t=c, another plane PL_{c+1} at time t=c+1, and another plane PL_{c+2} at time t=c+2. The stereo camera 41 and the laser radar 42 repeat the same process until a plane PL_{c+N} is detected at time t=c+N. Ultimately, as many as N planes PL, through PL_{c+N} are detected.

The N planes PL_{c} through PL_{c+N} may be different from one another. Alternatively, the N planes PL_{c} through PL_{c+N} may be derived from one plane PL as viewed from the stereo camera 41 and the laser radar 42 in different directions (at different angles).

Also, the setup in which one plane PL is sensed multiple times by the stereo camera 41 and by the laser radar 42 in different directions may be implemented either with the stereo camera 41 and laser radar 42 fixed in position to let one plane PL vary in direction, or with one plane PL fixed in position to let the stereo camera 41 and laser radar 42 vary in position.

### 5. Vehicle Mount Examples

The signal processing system 21 may be mounted, for example, on vehicles such as cars and trucks as part of the object detection system.

In the case where the stereo camera 41 and laser radar 42 are mounted on the vehicle in a manner facing forward, the signal processing system 21 detects objects ahead of the vehicle as target objects. However, the direction in which to detect objects is not limited to the forward direction of the vehicle. For example, in the case where the stereo camera 41 and laser radar 42 are mounted on the vehicle to face backward, the stereo camera 41 and laser radar 42 in the signal processing system 21 detect objects behind the vehicle as target objects.

The timing for the signal processing system 21 mounted on the vehicle to carry out the calibration process may be before the vehicle is shipped and after the shipment of the vehicle. Here, the calibration process performed before the vehicle is shipped is referred to as the pre-shipment calibration process, and the calibration process carried out after shipment of the vehicle is referred to as the running calibration process. In the running calibration process, it is possible to adjust variations in the relative positional relations having occurred after shipment due to aging, heat, or vibrations, for example.

In the pre-shipment calibration process, the relative positional relations between the stereo camera 41 and the laser radar 42 set up during the manufacturing process are detected and stored (registered) into the storage part 67.

The preliminary calibration data stored beforehand into the storage part 67 in the pre-shipment calibration process may be the data indicative of the relative positional relations between the stereo camera 41 and the laser radar 42 at design time, for example.

The pre-shipment calibration process may be carried out using an ideal, known calibration environment. For example, structures of multiple planes made with materials or textures easily recognizable by different types of sensors such as the stereo camera 41 and laser radar 42 may be arranged as target objects in the visual field ranges of the stereo camera 41 and laser radar 42. The multiple planes may then be detected by single-frame sensing.

On the other hand, the running calibration process after shipment of the vehicle is required to be performed while the vehicle is being used, except for cases where the calibration is carried out in a repair shop for example. Unlike the above-mentioned pre-shipment calibration process, the running calibration process is thus difficult to perform in an ideal, known calibration environment.

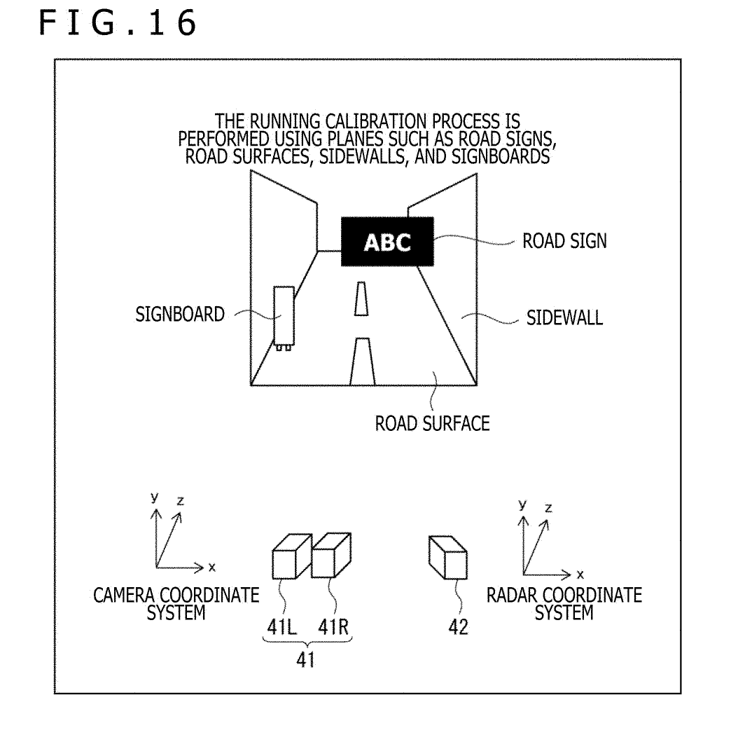

The signal processing system 21 therefore carries out the running calibration process using planes that exist in the actual environment, such as road signs, road surfaces, sidewalls, and signboards, as depicted in FIG. 16 for example. Image recognition technology based on machine learning may be used for plane detection. Alternatively, the locations suitable for calibration and the positions of planes such as signboards in such locations may be recognized on the basis of the current position information about the vehicle acquired from the global navigation satellite system (GNSS) typified by the global positioning system (GPS) and in accordance with the map information and three-dimensional map information prepared beforehand. As the vehicle moves to the locations suitable for calibration, the planes may be detected. During plane detection contingent on the actual environment, it is difficult to detect multiple planes with high confidence levels by single-frame sensing. Thus single-frame sensing may be performed multiple times, as explained with reference to FIG. 15, to detect and store pairs of corresponding planes before the running calibration process is carried out.

Further, it is to be noted that when the vehicle is moving at high speed, blurs and vibrations from motion will conceivably reduce the accuracy of estimating three-dimensional depth information. For this reason, it is preferred that the running calibration process be not carried out during rapid movement of the vehicle.

### <Running Calibration Process>

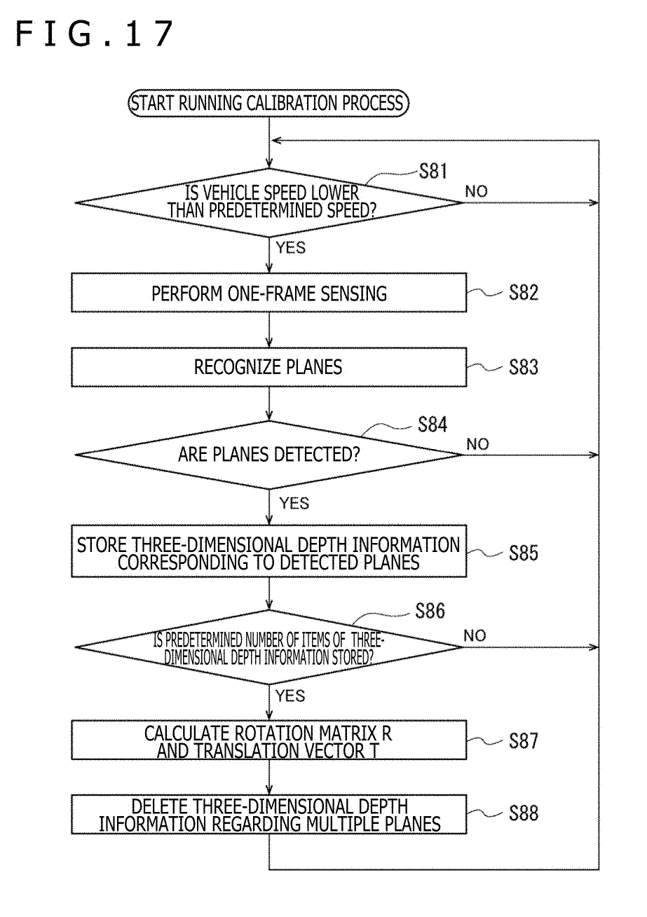

Explained below with reference to the flowchart of FIG. 17 is the running calibration process performed by the signal processing system 21 mounted on the vehicle. This process is carried out continuously as long as the vehicle is in motion, for example.

First in step S81, a control part determines whether the vehicle speed is lower than a predetermined speed. Step S81 involves determining whether the vehicle is stopped or running at low speed. The control part may be an electronic control unit (ECU) mounted on the vehicle or may be provided as part of the signal processing apparatus 43.

The process of step S81 is repeated until the vehicle speed is determined to be lower than the predetermined speed.

In the case where it is determined in step S81 that the vehicle speed is lower than the predetermined speed, control is transferred to step S82. In step S82, the control part causes the stereo camera 41 and laser radar 42 to perform single-frame sensing. Under control of the control part, the stereo camera 41 and the laser radar 42 carry out single-frame sensing.

In step S83, the signal processing apparatus 43 recognizes planes such as road signs, road surfaces, sidewalls, or signboards using image recognition technology. For example, the matching processing part 61 in the signal processing apparatus 43 recognizes planes including road signs, road surfaces, sidewalls, and signboards using either the base camera image or the reference camera image supplied from the stereo camera 41.

In step S84, the signal processing apparatus 43 determines whether any plane has been detected using image recognition technology.

In the case where it is determined in step S84 that no plane has been detected, control is returned to step S81.

On the other hand, in the case where it is determined in step S84 that a plane has been detected, control is transferred to step S85. In step S85, the signal processing apparatus 43 calculates three-dimensional depth information corresponding to the detected plane, and stores the calculated information into the storage part 67.

That is, the matching processing part 61 generates a parallax map corresponding to the detected plane and outputs the generated parallax map to the three-dimensional depth calculating part 62. On the basis of the parallax map of the plane supplied from the matching processing part 61, the three-dimensional depth calculating part 62 calculates the three-dimensional information corresponding to the plane and stores the calculated information into the storage part 67. The three-dimensional depth calculating part 63 also calculates the three-dimensional information corresponding to the plane on the basis of the rotation angle (θ, φ) and ToF of the emitted laser light supplied from the laser radar 42, and stores the calculated information into the storage part 67.

In step S86, the signal processing apparatus 43 determines whether a predetermined number of items of the plane depth information have been stored in the storage part 67.

In the case where it is determined in step S86 that the predetermined number of the items of the plane depth information have yet to be stored in the storage part 67, control is returned to step S81. The above-described processes of steps S81 to S86 are thus repeated until it is determined in step S86 that the predetermined number of the items of the plane depth information have been stored in the storage part 67. The number of the items of plane depth information to be stored in the storage part 67 is determined beforehand.

Then in the case where it is determined in step S86 that the predetermined number of the items of plane depth information have been stored in the storage part 67, control is transferred to step S87. In step S87, the signal processing apparatus 43 performs the process of calculating the rotation matrix R and translation vector T and thereby updating the currently stored rotation matrix R and translation vector T (preliminary calibration data) in the storage part 67.

The process of step S87 corresponds to the processing performed by the blocks downstream of the three-dimensional depth calculating parts 62 and 63 in the signal processing apparatus 43. In other words, the process of step S87 corresponds to the processes of steps S4 and S7 to S15 in FIG. 9 or to the processes of steps S44 and S47 to S62 in FIGS. 13 and 14.

In step S88, the signal processing apparatus 43 deletes the three-dimensional depth information regarding multiple planes stored in the storage part 67.

After step S88, control is returned to step S81. The above-described processes of steps S81 to S88 are then repeated.

The running calibration process is carried out as described above.

The calibration process of the present technology makes it possible to obtain the relative positional relations between different types of sensors with higher accuracy. As a result, the registration of images on pixel levels and the sensor fusion are made possible. The registration of images is the process of converting multiple images of different coordinate systems into those of the same coordinate system. The sensor fusion is the process of integrally processing the sensor signals from different types of sensors in such a manner that the drawbacks of the sensors are mutually compensated so as to estimate depths and recognize objects with higher confidence levels.

For example, in the case where the different types of sensors are the stereo camera 41 and the laser radar 42 as in the above-described embodiments, the stereo camera 42 is no good at measuring distances at flat or dark places but this drawback is compensated by the active laser radar 42. On the other hand, the laser radar 42 is poor at spatial resolution but this drawback is compensated by the stereo camera 41.

Furthermore, the advanced driving assistant systems (ADAS) and self-driving systems for vehicles are provided to detect obstacles ahead on the basis of depth information obtained by depth sensors. The calibration process of the present technology is also effective in the process of obstacle detection with these systems.

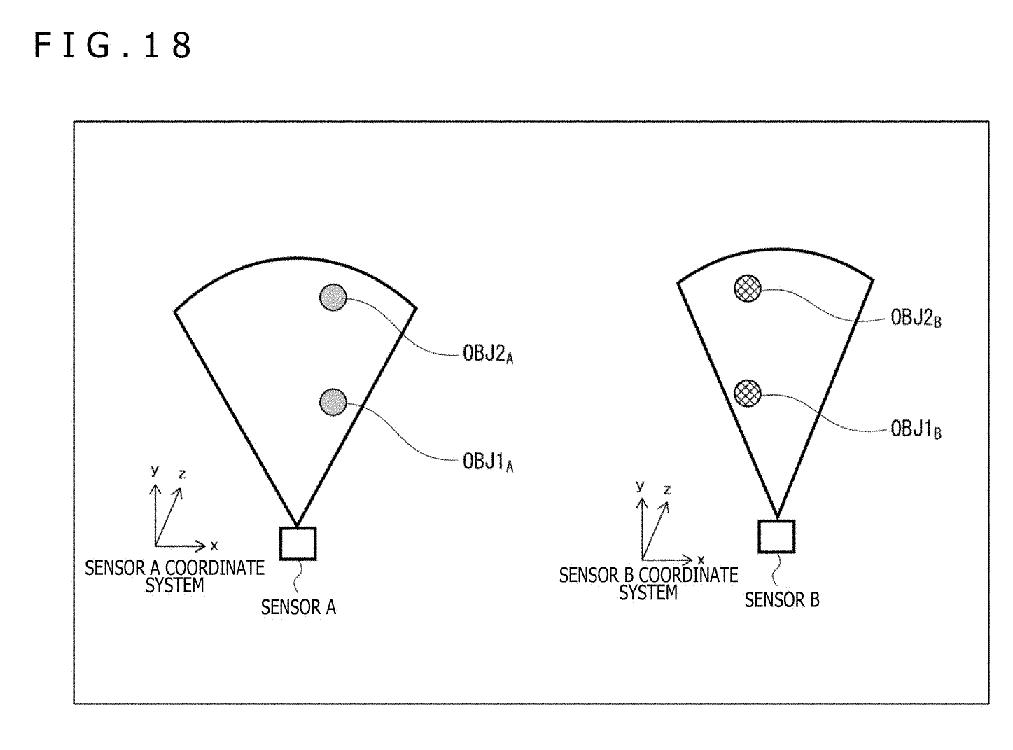

For example, suppose that different types of sensors A and B have detected two obstacles OBJ1 and OBJ2 as depicted in FIG. 18.

In FIG. 18, the obstacle OBJ1 detected by the sensor A is indicated as an obstacle OBJ1_{A} in a sensor A coordinate system and the obstacle OBJ2 detected by the sensor A is presented as an obstacle OBJ2_{A} in the sensor A coordinate system. Likewise, the obstacle OBJ1 detected by the sensor B is indicated as an obstacle OBJ1_{B} in a sensor B coordinate system and the obstacle OBJ2 detected by the sensor B is presented as an obstacle OBJ2_{B} in the sensor B coordinate system.

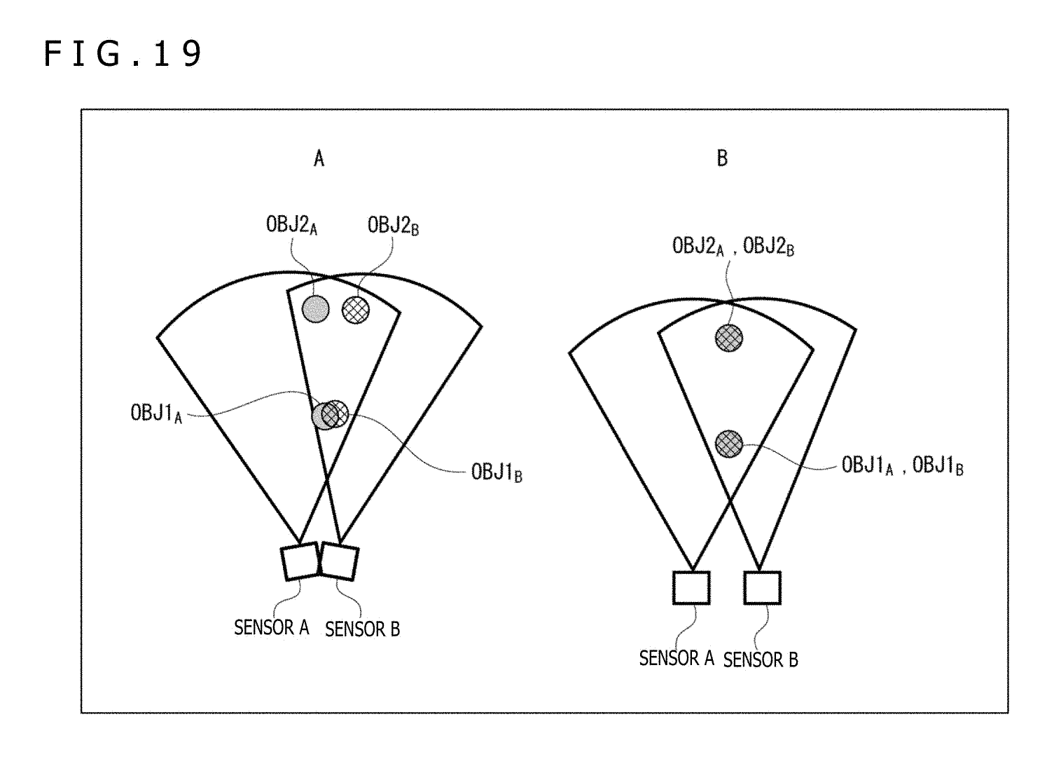

In the case where the relative positional relations between the sensor A and the sensor B are not accurate, the obstacle OBJ1 or OBJ2, actually a single obstacle, may appear to be two different obstacles as depicted in Subfigure A of FIG. 19. Such a phenomenon becomes more conspicuous the longer the distance from the sensors to the obstacle. Thus in Subfigure A of FIG. 19, the discrepancy between two positions of the obstacle OBJ2 detected by the sensors A and B is larger than the discrepancy between two positions of the obstacle OBJ1 detected by the sensors A and B.

On the other hand, in the case where the relative positional relations between the sensors A and B are accurately adjusted, an obstacle far away from the sensors can still be detected as a single obstacle as illustrated in Subfigure B of FIG. 19.

The calibration process of the present technology permits acquisition of the relative positional relations between different types of sensors with higher accuracy. This in turn enables early detection of obstacles and the recognition of such obstacles with higher confidence levels.

In connection with the above embodiments, examples were explained in which the relative positional relations are detected between the stereo camera 41 and the laser radar 42 as the different types of sensors. Alternatively, the calibration process of the present technology may be applied to sensors other than the stereo camera and the laser radar (LiDAR) such as a ToF camera and a structured-light sensor.

In other words, the calibration process of the present technology may be applied to any sensors as long as they are capable of detecting the position (distance) of a given object in a three-dimensional space defined by the X, Y, and Z axes, for example. It is also possible to apply the calibration process of this technology to cases where the relative positional relations are detected not between two different types of sensors but between two sensors of the same type outputting three-dimensional position information.

It is preferred that two sensors of different types or of the same type perform the sensing at the same time. Still, there may be a predetermined difference in sensing timing between the sensors. In this case, the amount of the motion corresponding to the time difference is estimated and compensated in such a manner that the two sensors are considered to provide sensor data at the same point in time. Then the motion-compensated sensor data is used to calculate the relative positional relations between the two sensors. In the case where the target object is not moving over a predetermined time difference, the sensor data acquired at different times encompassing the time difference may be used unmodified to calculate the relative positional relations between the two sensors.

In the examples above, it was explained for the purpose of simplification that the imaging range of the stereo camera 41 is the same as the projection range of laser light of the laser radar 42. Alternatively, the imaging range of the stereo camera 41 may be different from the projection range of laser light of the laser radar 42. In such a case, the above-described calibration process is performed using planes detected from an overlapping region between the imaging range of the stereo camera 41 and the laser light projection range of the laser radar 42. The non-overlapping regions between the imaging range of the stereo camera 41 and the laser light projection range of the laser radar 42 may be excluded from the objects targeted for the calculation of three-dimensional depth information and for the plane detecting process. Even if the non-overlapping regions are not excluded, they are not problematic because no planes are detected therefrom.

### 6. Typical Computer Configuration

The series of the processing described above including the calibration process may be executed either by hardware or by software. In the case where a software-based series of processing is to be carried out, the programs constituting the software are installed into a suitable computer. Such computers may include those with the software incorporated in their dedicated hardware beforehand, and those such as a general-purpose personal computer capable of executing diverse functions based on various programs installed therein.

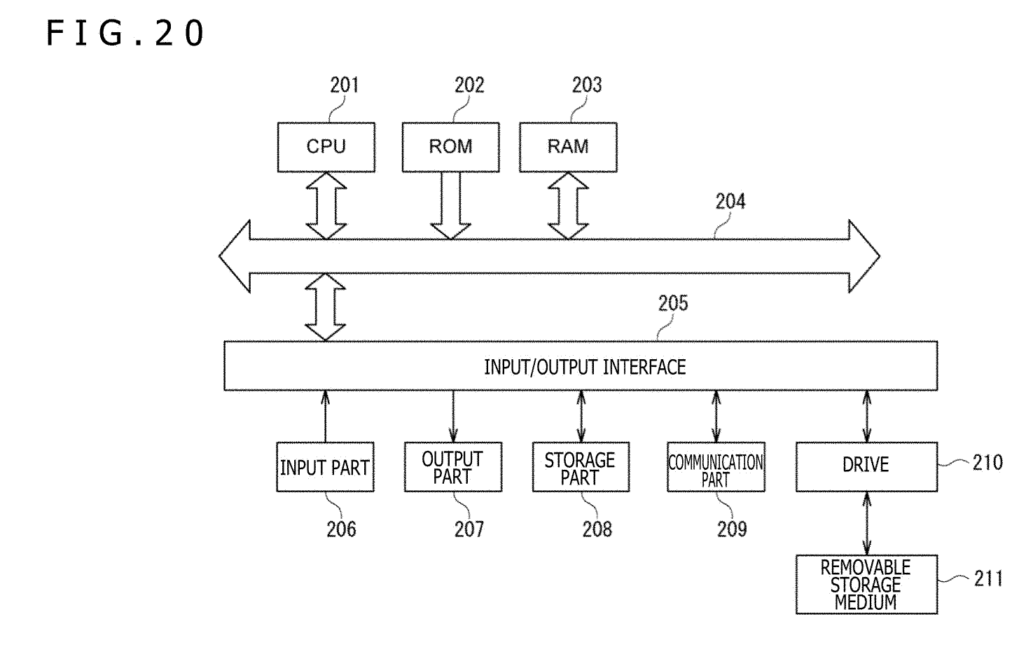

FIG. 20 is a block diagram depicting a typical hardware configuration of a computer that executes the above-described series of processing using programs.

In the computer, a central processing unit (CPU) 201, a read-only memory (ROM) 202, and a random access memory (RAM) 203 are interconnected via a bus 204.

The bus 204 is further connected with an input/output interface 205. The input/output interface 205 is connected with an input part 206, an output part 207, a storage part 208, a communication part 209, and a drive 210.

The input part 206 is typically made up of a keyboard, a mouse, and a microphone. The output part 207 is composed of a display unit and speakers, for example. The storage part 208 is generally formed by a hard disk drive or a nonvolatile memory. The communication part 209 is typically constituted by a network interface. The drive 210 accommodates and drives removable storage medium 211 such as a magnetic disk, an optical disk, a magneto-optical disk, or a semiconductor memory.

In the computer constituted as described above, the CPU 201 loads the programs held in the storage par 208 into the RAM 203 via the input/output interface 205 and bus 204, and executes the loaded programs to carry out the above-described series of processing.

In the computer, the programs may be installed into the storage part 208 via the input/output interface 205 from the removable storage medium 211 loaded in the drive 210. Alternatively, the programs may be installed into the storage part 208 after being received by the communication part 209 via wired or wireless transmission media such as local area networks, the Internet, or digital satellite broadcasts. As another alternative, the programs may be preinstalled in the ROM 202 or in the storage part 208.

### 7. Typical Configuration of the Vehicle Control System

The technology of the present disclosure may be applied to diverse products. For example, the present technology may be implemented as an apparatus mounted on any one of diverse types of vehicles including cars, electric vehicles, hybrid electric vehicles, and motorcycles.

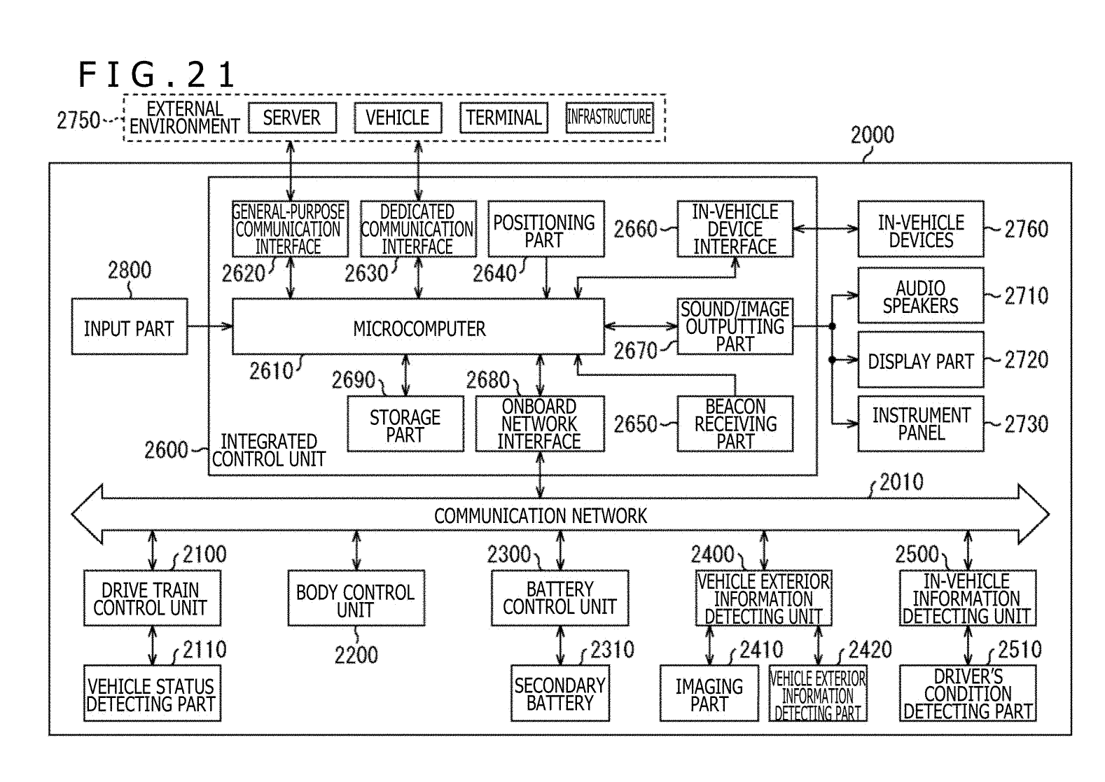

FIG. 21 is a block diagram depicting a typical overall configuration of a vehicle control system 2000 to which the technology of the present disclosure may be applied. The vehicle control system 2000 has multiple electronic control units interconnected therein via a communication network 2010. In the example depicted in FIG. 21, the vehicle control system 2000 includes a drive train control unit 2100, a body control unit 2200, a battery control unit 2300, a vehicle exterior information detecting unit 2400, an in-vehicle information detecting unit 2500, and an integrated control unit 2600. These multiple control units may be interconnected via the communication network 2010 such as a controller area network (CAN), a local interconnect network (LIN), a local area network (LAN), or an onboard communication network complying with a suitable protocol such as FlexRay (registered trademark).

Each of the control units includes a microcomputer that performs arithmetic processing in accordance with various programs, a storage part that stores the programs to be executed by the microcomputer and parameters for use in diverse arithmetic operations, and drive circuits that drive the apparatuses targeted for diverse controls.

Each control unit includes a network interface for communicating with the other control units via the communication network 2010, and a communication interface for communicating with onboard or exterior apparatuses or sensors in wired or wireless fashion. FIG. 21 depicts a functional configuration of the integrated control unit 2600 including a microcomputer 2610, a general-purpose communication interface 2620, a dedicated communication interface 2630, a positioning part 2640, a beacon receiving part 2650, an in-vehicle device interface 2660, a sound/image outputting part 2670, an onboard network interface 2680, and a storage part 2690. Likewise, the other control units each include the microcomputer, communication interface, and other components.

The drive train control unit 2100 controls the operations of the apparatuses related to the drive train of the vehicle in accordance with diverse programs. For example, the drive train control unit 2100 functions as a unit that controls a drive power generating apparatus such as an internal combustion engine or drive motors for generating the drive power of the vehicle, a drive power transmission mechanism for transmitting the drive power to the wheels, a steering mechanism for adjusting the rudder angle of the vehicle, and a braking apparatus for generating the braking power of the vehicle. The drive train control unit 2100 may also include the function of such control apparatuses as an antilock brake system (ABS) or an electronic stability control (ESC) apparatus.

The drive train control unit 2100 is connected with a vehicle status detecting part 2110. The vehicle status detecting part 2110 includes at least one of such sensors as a gyro sensor for detecting the angular velocity of the axial rotation movement of the vehicle body, an acceleration sensor for detecting the acceleration of the vehicle; and sensors for detecting the amount of operation of the accelerator pedal, the amount of operation of the brake pedal, the rudder angle of the steering wheel, the engine revolutions, and the rotating speed of the wheels. The drive train control unit 2100 performs arithmetic processing using signals input from the vehicle status detecting part 2110 to control the internal combustion engine, drive motors, electric power steering apparatus, or braking apparatus accordingly.

The body control unit 2200 controls the operations of various apparatuses mounted on the vehicle body in accordance with diverse programs. For example, the body control unit 2200 functions as a unit that controls a keyless entry system, a smart key system, and powered window apparatuses, as well as diverse lamps including headlamps, back lamps, brake lights, winkers, and fog lamps. In such a case, radio waves emitted by portable devices replacing the keys or signals from diverse switches may be input to the body control unit 2200. The body control unit 2200 receives input of these radio waves or signals to control the door locking apparatus, powered window apparatuses, and lamps, for example.

The battery control unit 2300 controls a secondary battery 2310, which is the power source for powering the drive motors in accordance with various programs. For example, information such as battery temperature, battery output voltage, and remaining battery capacity is input to the batter control unit 2300 from a battery apparatus that includes the secondary battery 2310. The battery control unit 2300 performs arithmetic processing using these signals to control the secondary batter 2310 for temperature adjustment or control a cooling apparatus attached to the battery apparatus, for example.

The vehicle exterior information detecting unit 2400 detects information exterior to the vehicle that carries the vehicle control system 2000. For example, the vehicle exterior information detecting unit 2400 is connected with at least either an imaging part 2410 or a vehicle exterior information detecting part 2420. The imaging part 2410 includes at least one of such cameras as a ToF (Time Of Fight) camera, a stereo camera, a monocular camera, an infrared camera, and other cameras. The vehicle exterior information detecting part 2420 includes, for example, an environment sensor for detecting the current weather or meteorological conditions, or a surrounding information detecting sensor for detecting nearby vehicles carrying the vehicle control system 2000 as well as obstacles or pedestrians in the surroundings.

The environment sensor may be at least one of such sensors as a raindrop sensor for detecting raindrops, a fog sensor for detecting fogs, a sunshine sensor for detecting the level of solar irradiation, and a snow sensor for detecting snowfalls. The surrounding information detecting sensor may be at least one of such sensors as an ultrasonic sensor, a radar apparatus; and a light detection and ranging, laser imaging detection and ranging (LIDAR) apparatus. The imaging part 2410 and the vehicle exterior information detecting part 2420 may each be provided either as an independent sensor or apparatus, or as an apparatus that integrates multiple sensors or apparatuses.

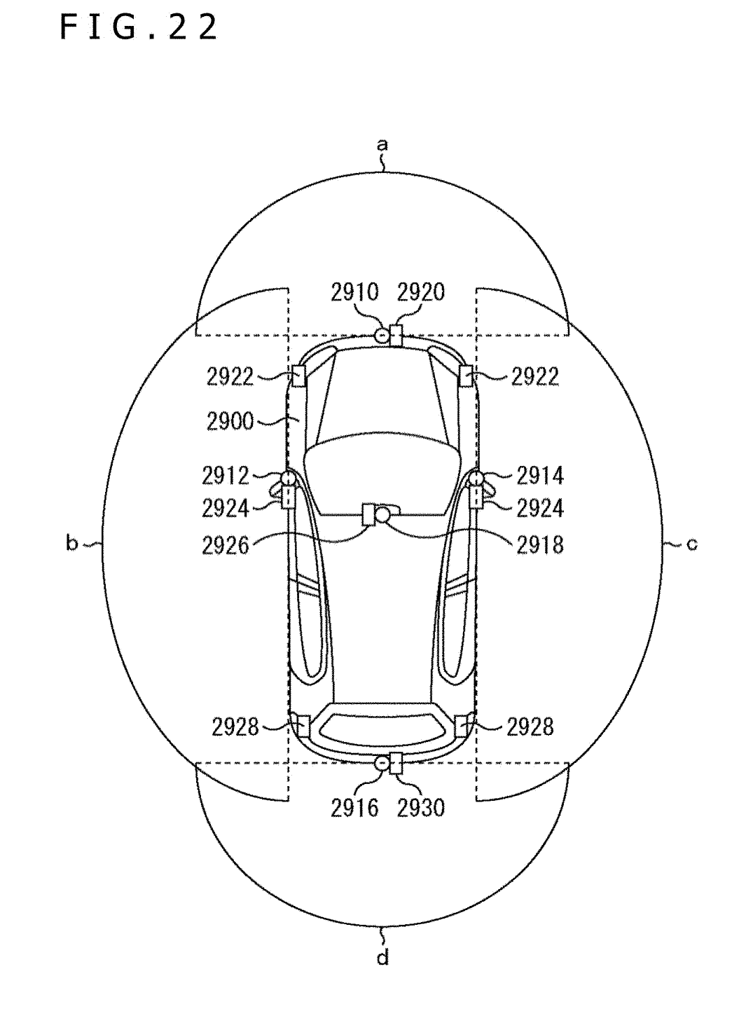

FIG. 22 indicates typical positions to which the imaging part 2410 and the vehicle exterior information detecting part 2420 are attached. Imaging parts 2910, 2912, 2914, 2916, and 2918 are attached, for example, to at least one of such positions as the front nose, side mirrors, and rear bumper of a vehicle 2900, and an upper portion of the windshield in the vehicle interior. The imaging part 2910 attached to the front nose and the imaging part 2918 attached to the upper portion of the windshield in the vehicle interior mainly acquire images from ahead of the vehicle 2900. The imaging parts 2912 and 2914 attached to the side mirrors mainly acquire images from alongside the vehicle 2900. The imaging part 2916 attached to the rear bumper or the backdoor mainly acquires images from behind the vehicle 2900. The imaging part 2918 attached to the upper portion of the windshield in the vehicle interior mainly detects vehicles ahead, pedestrians, obstacles, traffic lights, traffic signs, or traffic lanes, for example.

Also, FIG. 22 illustrates typical imaging ranges of the imaging parts 2910, 2912, 2914, and 2916. The imaging range “a” is that of the imaging part 2910 attached to the front nose. The imaging ranges “b” and “c” are those of the imaging parts 2912 and 2914, respectively, attached to the side mirrors. The imaging range “d” is that of the imaging part 2916 attached to the rear bumper or to the backdoor. For example, getting the image data from the imaging parts 2910, 2912, 2914, and 2916 overlaid on one another provides a bird's-eye view of the vehicle 2900.

Vehicle exterior information detecting parts 2920, 2922, 2924, 2926, 2928, and 2930 attached to the front, rear, sides, and corners of the vehicle 2900 as well as to the upper portion of the windshield in the vehicle interior may be ultrasonic sensors or radar apparatuses, for example. The vehicle exterior information detecting parts 2920, 2926, and 2930 attached to the front nose, rear bumper, and backdoor of the vehicle 2900 as well as to the upper portion of the windshield in the vehicle interior may be LIDAR apparatuses, for example. These vehicle exterior information detecting parts 2920 to 2930 are mainly used to detect vehicles ahead, pedestrians, and obstacles.

Returning to FIG. 21, the description continues below. The vehicle exterior information detecting unit 2400 causes the imaging part 2410 to capture images of the vehicle exterior and receives the captured image data therefrom. Also, the vehicle exterior information detecting unit 2400 receives detected information from the connected vehicle exterior information detecting part 2420. In the case where the vehicle exterior information detecting part 2420 is an ultrasonic sensor, a radar apparatus, or a LIDAR apparatus, the vehicle exterior information detecting unit 2400 causes the sensor to emit ultrasonic waves or electromagnetic waves, and receives information constituted by the received waves being reflected. On the basis of the received information, the vehicle exterior information detecting unit 2400 may perform the process of detecting objects such as people, cars, obstacles, road signs, or letters painted on the road surface, or carry out the process of recognizing the environment such as rainfalls and road surface conditions.

Also on the basis of the received information, the vehicle exterior information detecting unit 2400 may calculate distances to objects exterior to the vehicle.

Furthermore, on the basis of the received image data, the vehicle exterior information detecting unit 2400 may perform an image recognition process of recognizing objects such as people, cars, obstacles, road signs, or letters painted on the road surface, or carry out the process of detecting distances. The vehicle exterior information detecting unit 2400 may perform such processes as distortion correction or position adjustment on the received image data, and may generate a bird's-eye image or a panoramic image by combining the image data acquired by different imaging parts 2410. The vehicle exterior information detecting unit 2400 may also perform the process of viewpoint conversion using the image data obtained by different imaging parts 2410.

The in-vehicle information detecting unit 2500 detects information regarding the vehicle interior. The in-vehicle information detecting unit 2500 is connected, for example, with a driver's condition detecting part 2510 that detects the driver's conditions. The driver's condition detecting part 2510 may include a camera for imaging the driver, biosensors for detecting biological information about the driver, or a microphone for collecting sounds from inside the vehicle, for example. The biosensors may be attached to the driver seat or to the steering wheel, for example, so as to collect biological information about the drive sitting on the driver seat or gripping the steering wheel. The in-vehicle information detecting unit 2500 may calculate the degree of fatigue or the degree of concentration of the driver or determine whether the driver is dozing off on the basis of the detected information input from the driver's condition detecting part 2510. The in-vehicle information detecting unit 2500 may also perform such processes as noise canceling on the collected audio signal.

The integrated control unit 2600 controls overall operations in the vehicle control system 2000 in accordance with various programs. The integrated control unit 2600 is connected with an input part 2800. The input part 2800 is implemented, for example, using apparatuses that can be manipulated by passengers, such as a touch panel, buttons, a microphone, switches, or levers. The input part 2800 may be a remote control apparatus that utilizes infrared rays or other radio waves, or an externally connected device such as a mobile phone or a personal digital assistant (PDA) corresponding to the operations of the vehicle control system 2000, for example. The input part 2800 may also be a camera. In this case, the passenger may input information to the camera by gesture. The input part 2800 may further include, for example, an input control circuit that generates input signals based on the information typically input by a passenger using the input part 2800, the input control circuit further outputting the generated signals to the integrated control unit 2600. The passenger may operate the input part 2800 to input diverse data and processing operation instructions to the vehicle control system 2000.

The storage part 2690 may include a random access memory (RAM) for storing various programs to be executed by the microcomputer, and a read-only memory (ROM) for storing diverse parameters, calculation results, or sensor values. The storage part 2690 may be implemented using a magnetic storage device such as a hard disc drive (HDD), a semiconductor storage device, an optical storage device, or a magneto-optical storage device, for example.

The general-purpose communication interface 2620 is a general-purpose interface that mediates communications with diverse devices in an external environment 2750. The general-purpose communication interface 2620 may utilize such cellular communication protocols as global system of mobile communications (GSM; registered trademark), WiMAX, long term evolution (LTE), or LTE-advanced (LTE-A); or other wireless communication protocols including wireless LAN (also known as Wi-Fi; registered trademark). The general-purpose communication interface 2620 may be connected with devices (e.g., application servers or control servers) on an external network (e.g., the Internet, cloud networks, or proprietary networks) via a base station or an access point, for example. Also, the general-purpose communication interface 2620 may be connected with terminals close to the vehicle (e.g., terminals carried by pedestrians, terminals installed in shops, or machine type communication (MTC) terminals) using peer-to-peer (P2P) technology, for example.

The dedicated communication interface 2630 is a communication interface that supports communication protocols designed for use with vehicles. The dedicated communication interface 2630 may utilize, for example, such standard protocols as wireless access in vehicle environment (WAVE), which is a combination of the lower-layer IEEE 802.11p and the upper-layer IEEE 1609, or dedicated short range communications (DSRC). Typically, the dedicated communication interface 2630 performs V2X communication, a concept that includes at least one of such communications as vehicle-to-vehicle communication, vehicle-to-infrastructure communication, and vehicle-to-pedestrian communication.

The positioning part 2640 performs positioning by receiving, from global navigation satellite system (GNSS) satellites for example, GNSS signals (e.g., global positioning system (GPS) signals from GPS satellites) to generate position information including the latitude, longitude, and altitude of the vehicle. Alternatively, the positioning part 2640 may identify the current position by exchanging signals with wireless access points. As another alternative, the positioning part 2640 may acquire position information from such terminals as a mobile phone having a positioning function, a PHS, or a smartphone.

The beacon receiving part 2650 may receive radio waves or electromagnetic waves emitted by wireless stations installed along the road for example, to acquire such information as the current position, traffic congestion, roads closed, and time to reach the destination. Incidentally, the function of the beacon receiving part 2650 may be included in the above-mentioned dedicated communication interface 2630.

The in-vehicle device interface 2660 is a communication interface that mediates connections with the microcomputer 2610 and with diverse devices inside the vehicle. The in-vehicle device interface 2660 may establish wireless connection using such wireless communication protocols as wireless LAN, Bluetooth (registered trademark), near field communication (NFC), or wireless USB (WUSB). Also, the in-vehicle device interface 2660 may establish wireless communication via a connection terminal (and a cable if necessary), not illustrated. The in-vehicle device interface 2660 exchanges control signals or data signals with a mobile device or a wearable device carried by a passenger, or with an information device brought in or attached to the vehicle, for example.

The onboard network interface 2680 is an interface that mediates communications between the microcomputer 2610 and the communication network 2010. The onboard network interface 2680 transmits and receives signals and other data in accordance with a predetermined protocol supported by the communication network 2010.

The microcomputer 2610 in the integrated control unit 2600 controls the vehicle control system 2000 in accordance with various programs on the basis of the information acquired via at least one of such components as the general-purpose communication interface 2620, dedicated communication interface 2630, positioning part 2640, beacon receiving part 2650, in-vehicle device interface 2660, and onboard network interface 2680. For example, on the basis of the information acquired from inside and outside of the vehicle, the microcomputer 2610 may calculate control target values for the drive power generating apparatus, steering mechanism, or braking apparatus, and may output control commands accordingly to the drive train control unit 2100. For example, the microcomputer 2610 may perform coordinated control for collision avoidance or shock mitigation of the vehicle, for follow-on driving on the basis of inter-vehicle distance, for cruise control, or for automated driving.

The microcomputer 2610 may generate local map information including information about the surroundings of the current vehicle position on the basis of information acquired via at least one of such components as the general-purpose communication interface 2620, dedicated communication interface 2630, positioning part 2640, beacon receiving part 2650, in-vehicle device interface 2660, and onboard network interface 2680. Also, on the basis of the acquired information, the microcomputer 2610 may predict such dangers as collision between vehicles, closeness to pedestrians, or entry into a closed road, and generate warning signals accordingly. The warning signals may be used to produce a warning beep or light a warning lamp, for example.

The sound/image outputting part 2670 transmits at least either a sound output signal or an image output signal to an output apparatus that can notify passengers in the vehicle or pedestrians outside the vehicle of visual or audio information. In the example of FIG. 21, audio speakers 2710, a display part 2720, and an instrument panel 2730 are indicated as the output apparatus. The display part 2720 may include at least one of such displays as an onboard display and a head-up display. The display part 2720 may also include an augmented reality (AR) display function. Alternatively, the output apparatus may be an apparatus other than those mentioned above, such as headphones, a projector, or lamps. In the case where the output apparatus is a display apparatus, the apparatus visually presents the results stemming from diverse processes performed by the microcomputer 2610 or the information received from other control units in the form of texts, images, tables, or graphs, for example. In the case where the output apparatus is a sound outputting apparatus, the apparatus converts audio signals derived from reproduced voice or sound data into analog signals for audible output.

Incidentally, in the example depicted in FIG. 21, at least two of the control units interconnected with one another via the communication network 2010 may be integrated into a single control unit. Alternatively, each of the control units may be constituted by multiple control units. As another alternative, the vehicle control system 2000 may be furnished with other control units, not illustrated. Also, part or all of the functions provided by any one of the control units explained above may be taken over by another control unit. That is, as long as information is transmitted and received via the communication network 2010, predetermined arithmetic processing may be carried out by any control unit. Likewise, the sensors or apparatuses connected with a given control unit may be reconnected to another control unit, with multiple control units being allowed to exchange detected information therebetween via the communication network 2010.

In the above-described vehicle control system 2000, the stereo camera 41 in FIG. 4 may be used, for example, in the imaging part 2410 in FIG. 21. The laser radar 42 in FIG. 4 may be used, for example, in the vehicle exterior information detecting part 2420 in FIG. 21. Also, the signal processing apparatus 43 in FIG. 4 may be used, for example, in the vehicle exterior information detecting unit 2400 in FIG. 21.

In the case where the stereo camera 41 in FIG. 4 is used in the imaging part 2410 in FIG. 21, the stereo camera 41 may be installed, for example, as the imaging part 2918 in FIG. 22 attached to the upper portion of the windshield in the vehicle interior.

In the case where the laser radar 42 in FIG. 4 is used in the vehicle exterior information detecting part 2420 in FIG. 21, the laser radar 42 may be installed, for example, as the vehicle exterior information detecting part 2926 in FIG. 22 attached to the upper portion of the windshield in the vehicle interior.

In that case, the vehicle exterior information detecting unit 2400 acting as the signal processing apparatus 43 detects highly accurately the relative positional relations between the imaging part 2410 as the stereo camera 41 on the one hand and the vehicle exterior information detecting part 2926 as the laser radar 42 on the other hand.

In this description, the processes executed by the computer in accordance with the programs need not be carried out chronologically as depicted in the flowcharts.

That is, the processes performed by the computer according to the programs may include those that are conducted parallelly or individually (e.g., parallel processes or object-oriented processes).

The programs may be processed by a single computer or by multiple computers on a distributed basis. The programs may also be transferred to a remote computer or computers for execution.

In this description, the term “system” refers to an aggregate of multiple components (e.g., apparatuses or modules (parts)). It does not matter whether all components are housed in the same enclosure. Thus a system may be configured with multiple devices housed in separate enclosures and interconnected via a network, or with a single apparatus that houses multiple modules in a single enclosure.

The embodiments of the present technology are not limited to those discussed above and may be modified or altered diversely within the scope of this technology.

For example, part or all of the multiple embodiments described above may be combined to devise other embodiments. The signal processing system 21 may include the configuration of only either the first embodiment or the second embodiment. The signal processing system 21 may alternatively include the configurations of both embodiments and selectively carry out the first or the second calibration process as needed.

For example, the present technology may be implemented as a cloud computing setup in which a single function is processed cooperatively by multiple networked devices on a shared basis.

Also, each of the steps discussed in reference to the above-described flowcharts may be executed either by a single apparatus or by multiple apparatuses on a shared basis.

Furthermore, if a single step includes multiple processes, these processes may be executed either by a single apparatus or by multiple apparatuses on a shared basis.

The advantageous effects stated in this description are only examples and are not limitative of the present technology. There may be other advantageous effects derived from but not covered by this description.

The present technology may be configured preferably as follows:

(1)

A signal processing apparatus including:

a positional relation estimating part configured to estimate positional relations between a first coordinate system and a second coordinate system, on the basis of corresponding relations between multiple planes in the first coordinate system obtained by a first sensor on the one hand and multiple planes in the second coordinate system obtained by a second sensor on the other hand.

(2)

The signal processing apparatus according as stated in paragraph (1) above, further including:

a plane correspondence detecting part configured to detect the corresponding relations between the multiple planes in the first coordinate system obtained by the first sensor on the one hand and the multiple planes in the second coordinate system obtained by the second sensor on the other hand.

(3)

The signal processing apparatus as stated in paragraph (2) above, in which the plane correspondence detecting part detects the corresponding relations between the multiple planes in the first coordinate system on the one hand and the multiple planes in the second coordinate system on the other hand, by use of preliminary arrangement information constituting preliminary positional relation information regarding the first coordinate system and the second coordinate system.

(4)

The signal processing apparatus as stated in paragraph (3) above, in which the plane correspondence detecting part detects the corresponding relations between the multiple planes obtained by converting the multiple planes in the first coordinate system to the second coordinate system using the preliminary arrangement information on the one hand, and the multiple planes in the second coordinate system on the other hand.

(5)

The signal processing apparatus as stated in paragraph (3) above, in which the plane correspondence detecting part detects the corresponding relations between the multiple planes in the first coordinate system on the one hand and the multiple planes in the second coordinate system on the other hand, on the basis of a cost function defined by an arithmetic expression that uses an absolute value of an inner product between normal lines to planes and an absolute value of a distance between the centers of gravity of point groups on planes.

(6)

The signal processing apparatus according as stated in any one of paragraphs (1) to (5) above, in which the positional relation estimating part estimates a rotation matrix and a translation vector as the positional relations between the first coordinate system and the second coordinate system.

(7)

The signal processing apparatus as stated in paragraph (6) above, in which the positional relation estimating part estimates, as a rotation matrix, the rotation matrix that maximizes the inner product between a normal vector of each of the planes in the first coordinate system, the normal vector being multiplied by the rotation matrix on the one hand, and a normal vector of each of the planes in the second coordinate system on the other hand.

(8)

The signal processing apparatus as stated in paragraph (7) above, in which the positional relation estimating part uses a peak normal vector as the normal vector of each of the planes in the first coordinate system or as the normal vector of each of the planes in the second coordinate system.

(9)

The signal processing apparatus as stated in paragraph (6) above, in which each of the planes is defined by a plane equation expressed by a normal vector and a coefficient part; and

the positional relation estimating part estimates the translation vector by solving an equation in which the coefficient part in a converted plane equation obtained by converting the plane equation of each of the planes in the first coordinate system to the second coordinate system equals the coefficient part in the plane equation of each of the planes in the second coordinate system.

(10)

The signal processing apparatus as stated in paragraph (6) above, in which the positional relation estimating part estimates the translation vector on the assumption that an intersection point between three planes in the first coordinate system coincides with an intersection point between three planes in the second coordinate system.

(11)

The signal processing apparatus as stated in any one of paragraphs (1) to (10) above, further including:

a first plane detecting part configured to detect, given three-dimensional coordinate values in the first coordinate system obtained by the first sensor, multiple planes in the first coordinate system; and

a second plane detecting part configured to detect, given three-dimensional coordinate values in the second coordinate system obtained by the second sensor, multiple planes in the second coordinate system.

(12)

The signal processing apparatus as stated in paragraph (11) above, further including:

a first coordinate value calculating part configured to calculate three-dimensional coordinate values in the first coordinate system from a first sensor signal output from the first sensor; and

a second coordinate value calculating part configured to calculate three-dimensional coordinate values in the second coordinate system from a second sensor signal output from the second sensor.

(13)

The signal processing apparatus as stated in paragraph (12) above, in which the first sensor is a stereo camera; and

the first sensor signal is an image signal representing a base camera image and a reference camera image both output from the stereo camera.

(14)

The signal processing apparatus as stated in paragraph (12) or (13) above, in which the second sensor is laser radar; and

the second sensor signal represents a rotation angle of laser light emitted by the laser radar and a time period from the time of laser light emission until receipt of the light reflected from an object.

(15)

The signal processing apparatus as stated in paragraph (11) above, in which the first plane detecting part and the second plane detecting part detect the multiple planes by performing a process of detecting one plane per frame multiple times.

(16)

The signal processing apparatus as stated in paragraph (15) above, in which, every time a plane is detected by the plane detecting process, a direction of the plane is changed.

(17)

The signal processing apparatus as stated in paragraph (11) above, in which the first plane detecting part and the second plane detecting part detect the multiple planes by performing a process of detecting multiple planes per frame.

(18)

A signal processing method including the step of causing a signal processing apparatus to estimate positional relations between a first coordinate system and a second coordinate system, on the basis of corresponding relations between multiple planes in the first coordinate system obtained by a first sensor on the one hand and multiple planes in the second coordinate system obtained by a second sensor on the other hand.

### REFERENCE SIGNS LIST

21 Signal processing system
41 Stereo camera
42 Laser radar
43 Signal processing apparatus
61 Matching processing part
62, 63 Three-dimensional depth calculating part
64, 65 Plane detecting part
66 Plane correspondence detecting part
67 Storage part
68 Positional relation estimating part
81, 82 Normal line detecting part
83, 84 Normal line peak detecting part
85 Peak correspondence detecting part
86 Positional relation estimating part
201 CPU
202 ROM
203 RAM
206 Input part
207 Output part
208 Storage part
209 Communication part
210 Drive

1. A signal processing apparatus comprising:
a positional relation estimating part configured to estimate positional relations between a first coordinate system and a second coordinate system, on a basis of corresponding relations between a plurality of planes in the first coordinate system obtained by a first sensor on the one hand and a plurality of planes in the second coordinate system obtained by a second sensor on the other hand.

2. The signal processing apparatus according to claim 1, further comprising:
a plane correspondence detecting part configured to detect the corresponding relations between the plurality of planes in the first coordinate system obtained by the first sensor on the one hand and the plurality of planes in the second coordinate system obtained by the second sensor on the other hand.

3. The signal processing apparatus according to claim 2, wherein the plane correspondence detecting part detects the corresponding relations between the plurality of planes in the first coordinate system on the one hand and the plurality of planes in the second coordinate system on the other hand, by use of preliminary arrangement information constituting preliminary positional relation information regarding the first coordinate system and the second coordinate system.

4. The signal processing apparatus according to claim 3, wherein the plane correspondence detecting part detects the corresponding relations between the plurality of planes obtained by converting the plurality of planes in the first coordinate system to the second coordinate system using the preliminary arrangement information on the one hand, and the plurality of planes in the second coordinate system on the other hand.

5. The signal processing apparatus according to claim 3, wherein the plane correspondence detecting part detects the corresponding relations between the plurality of planes in the first coordinate system on the one hand and the plurality of planes in the second coordinate system on the other hand, on a basis of a cost function defined by an arithmetic expression that uses an absolute value of an inner product between normal lines to planes and an absolute value of a distance between the centers of gravity of point groups on planes.

6. The signal processing apparatus according to claim 1, wherein the positional relation estimating part estimates a rotation matrix and a translation vector as the positional relations between the first coordinate system and the second coordinate system.

7. The signal processing apparatus according to claim 6, wherein the positional relation estimating part estimates, as the rotation matrix, a rotation matrix that maximizes the inner product between a normal vector of each of the planes in the first coordinate system, the normal vector being multiplied by the rotation matrix on the one hand, and a normal vector of each of the planes in the second coordinate system on the other hand.

8. The signal processing apparatus according to claim 7, wherein the positional relation estimating part uses a peak normal vector as the normal vector of each of the planes in the first coordinate system or as the normal vector of each of the planes in the second coordinate system.

9. The signal processing apparatus according to claim 6, wherein each of the planes is defined by a plane equation expressed by a normal vector and a coefficient part; and
the positional relation estimating part estimates the translation vector by solving an equation in which the coefficient part in a converted plane equation obtained by converting the plane equation of each of the planes in the first coordinate system to the second coordinate system equals the coefficient part in the plane equation of each of the planes in the second coordinate system.

10. The signal processing apparatus according to claim 6, wherein the positional relation estimating part estimates the translation vector on the assumption that an intersection point between three planes in the first coordinate system coincides with an intersection point between three planes in the second coordinate system.

11. The signal processing apparatus according to claim 1, further comprising:
a first plane detecting part configured to detect, given three-dimensional coordinate values in the first coordinate system obtained by the first sensor, a plurality of planes in the first coordinate system; and
a second plane detecting part configured to detect, given three-dimensional coordinate values in the second coordinate system obtained by the second sensor, a plurality of planes in the second coordinate system.

12. The signal processing apparatus according to claim 11, further comprising:
a first coordinate value calculating part configured to calculate three-dimensional coordinate values in the first coordinate system from a first sensor signal output from the first sensor; and
a second coordinate value calculating part configured to calculate three-dimensional coordinate values in the second coordinate system from a second sensor signal output from the second sensor.

13. The signal processing apparatus according to claim 12, wherein the first sensor is a stereo camera, and the first sensor signal is an image signal representing a base camera image and a reference camera image both output from the stereo camera.

14. The signal processing apparatus according to claim 12, wherein the second sensor is laser radar, and the second sensor signal represents a rotation angle of laser light emitted by the laser radar and a time period from the time of laser light emission until receipt of the light reflected from an object.

15. The signal processing apparatus according to claim 11, wherein the first plane detecting part and the second plane detecting part detect the plurality of planes by performing a process of detecting one plane per frame a plurality of times.

16. The signal processing apparatus according to claim 15, wherein, every time a plane is detected by the plane detecting process, a direction of the plane is changed.

17. The signal processing apparatus according to claim 11, wherein the first plane detecting part and the second plane detecting part detect the plurality of planes by performing a process of detecting a plurality of planes per frame.

18. A signal processing method comprising the step of causing a signal processing apparatus to estimate positional relations between a first coordinate system and a second coordinate system, on a basis of corresponding relations between a plurality of planes in the first coordinate system obtained by a first sensor on the one hand and a plurality of planes in the second coordinate system obtained by a second sensor on the other hand.
